(19) United States
(12) Patent Application Publication
(10) Pub. No.: US 2026/0165383 A1
(43) Pub. Date: Jun. 18, 2026

(54) HEATER ASSEMBLY AND AEROSOL GENERATING DEVICE COMPRISING SAME

(71) Applicant: KT&G CORPORATION, Daejeon (KR)

(72) Inventors: In Su PARK, Daejeon (KR); Chan Min KWON, Daejeon (KR); Sung Jong KI, Daejeon (KR); Tae Kyun KIM, Daejeon (KR); Ick Joong KIM, Daejeon (KR); Mi Jeong LEE, Daejeon (KR); John Tae LEE, Daejeon (KR); Tae Kyung LEE, Daejeon (KR)

(73) Assignee: KT&G CORPORATION, Daejeon (KR)

(21) Appl. No.: 18/993,570

(22) PCT Filed: Aug. 31, 2023
(86) PCT No.: PCT/KR2023/013013

§ 371 Date: Jan. 12, 2025

(30) Foreign Application Priority Data
Aug. 31, 2022 (KR) 10-2022-0110268
Aug. 30, 2023 (KR) 10-2023-0114704
Aug. 30, 2023 (KR) 10-2023-0114705
Aug. 30, 2023 (KR) 10-2023-0114835

(51) Int. Cl. A24F 40/465; A24F 40/48

(52) U.S. Cl. CPC A24F 40/465; A24F 40/48

(57) ABSTRACT

A heater assembly comprises an oscillator generating a microwave in a designated frequency band, and a resonance unit configured to receive the microwave generated by the oscillator through a coupler and cause the received microwave to resonate to generate an electric field, wherein the resonance unit comprises an outer conductor including an accommodation space for accommodating an aerosol generating article, a first inner conductor surrounding one region of the aerosol generating article accommodated in the accommodation space, and a second inner conductor surrounding another region of the aerosol generating article accommodated in the accommodation space, and the aerosol generating article accommodated in the accommodation space is heated by an electric field generated by the resonance unit.

### TECHNICAL FIELD

Embodiments relate to a heater assembly that may generate an aerosol by heating an aerosol generating article by using a dielectric heating method, and an aerosol generating device including the aerosol generating article.

### BACKGROUND ART

Recently, there has been an increasing demand for alternative methods that reduce disadvantages of general cigarettes. For example, there has been an increasing demand for a device (or an “aerosol generating device”) that generates an aerosol by heating an aerosol generating material (or an “aerosol generating article”) by using the aerosol generating device, instead of a method of generating an aerosol by burning a cigarette.

Aerosol generating devices that generate an aerosol by heating an aerosol generating material by using a resistance heating or induction heating method are common, but recently, a dielectric heating type aerosol generating device that heats an aerosol generating material by using microwaves has been proposed.

The dielectric heating type aerosol generating device refers to a device that may generate heat in a dielectric included in an aerosol generating material by using resonance of microwaves and may heat the aerosol generating material by using the heat generated in the dielectric.

In order to increase usability of the dielectric heating type aerosol generating device, a heater assembly for generating the resonance of microwaves needs to be reduced in size, and when the heater assembly is reduced in size, the usability may be increased, but dielectric heating efficiency may be decreased. Accordingly, there is a growing need for a dielectric heating type aerosol generating device including a heater assembly having a new structure that may reduce the size of the heater assembly and increase dielectric heating efficiency.

### DISCLOSURE

### Technical Problem

In order to reduce a size of a heater assembly, a size of a resonance unit that generates resonance of microwaves has to be reduced, but when the size of the resonance unit is reduced, a distance between the resonance unit and an aerosol generating material is reduced, and accordingly, the amount of aerosols, which spread from the aerosol generating material toward the resonance unit, may be increased.

During the use of an aerosol generating device, some of aerosols reaching the resonance unit may be liquefied, and accordingly, droplets generated from the liquefied aerosols may accumulate inside the resonance unit.

Also, when a distance between the aerosol generating material and the resonance unit is closer, the amount of heat transferred from the aerosol generating material to the resonance unit may be increased, and accordingly, the temperature of the resonance unit is overheated.

When the amount of droplets accumulated in the resonance unit is increased or the resonance unit is overheated to an excessively high temperature, resonance efficiency of the resonance unit may decrease and the entire heating efficiency of the heater assembly may decrease, and accordingly, a resonance unit having a new structure, which may be reduced in size and reduce the amount of aerosols or heat reaching the resonance unit from an aerosol generating material, is required.

Various embodiments of the present disclosure provide a heater assembly that may reduce the amount of aerosols spreading from an aerosol generating material to a resonance unit and improve insulation performance of the resonance unit and an aerosol generating device including the heater assembly, to reduce a size of the heater assembly and increase dielectric heating efficiency.

Problems to be solved by embodiments of the present disclosure are not limited to the problems described above, and problems not described above may be clearly understood by a person having ordinary skill in the art to which the embodiments belong from the present specification and the attached drawings.

### Technical Solution

According to an embodiment, a heater assembly includes an oscillator configured to generate a microwave in a designated frequency band; and a resonance unit configured to receive the microwave generated by the oscillator through a coupler and cause the received microwave to resonate to generate an electric field, wherein the resonance unit includes an outer conductor including an accommodation space for accommodating an aerosol generating article, a first inner conductor surrounding one region of the aerosol generating article accommodated in the accommodation space, and a second inner conductor surrounding another region of the aerosol generating article accommodated in the accommodation space, and the aerosol generating article accommodated in the accommodation space is heated by the electric field generated by the resonance unit.

According to an embodiment, an aerosol generating device includes a housing including an insertion hole into which an aerosol generating article is inserted and the heater assembly for heating the aerosol generating article inserted through the insertion hole.

### Advantageous Effects

A heater assembly and an aerosol generating device according to various embodiments of the present disclosure reduce the amount of heat transferred from an aerosol generating article to a resonant unit, and thus, the resonant unit may be prevented from being overheated.

Also, a heater assembly and an aerosol generating device according to various embodiments of the present disclosure may prevent droplets from being generated inside a resonant unit, and accordingly, heating efficiency may be prevented from being decreased due to the droplets.

Effects of the embodiments are not limited to the effects described above, and effects that are not described may be clearly understood by those skilled in the art to which the embodiments belong from the present specification and the attached drawings.

### DESCRIPTION OF DRAWINGS

FIG. 1 is a perspective view of an aerosol generating device according to an embodiment.

FIG. 2 is an internal block diagram of an aerosol generating device according to an embodiment.

FIG. 3 is an internal block diagram of a dielectric heating unit of FIG. 2.

FIG. 4 is a perspective view of a heater assembly according to an embodiment.

FIG. 5 is a cross-sectional view of the heater assembly of FIG. 4.

FIG. 6 is a perspective view of a heater assembly according to another embodiment.

FIG. 7 is a cross-sectional view of the heater assembly of FIG. 6.

FIG. 8 is a cross-sectional view of a heater assembly according to another embodiment.

FIG. 9A illustrates an electric field distribution inside the heater assembly.

FIG. 9B illustrates a heating density distribution of an aerosol generating article heated by the heater assembly.

FIG. 10 is a perspective view of a heater assembly according to another embodiment.

FIG. 11 is a cross-sectional view of the heater assembly of FIG. 10.

FIG. 12 is a perspective view of a heater assembly according to another embodiment.

FIG. 13 is a cross-sectional view of the heater assembly of FIG. 12.

FIG. 14 illustrates an air movement path of the heater assembly of FIG. 12.

FIG. 15A illustrates an electric field distribution inside the heater assembly.

FIG. 15B illustrates a heating density distribution of an aerosol generating article heated by the heater assembly.

FIG. 16 is a cross-sectional view of a heater assembly according to another embodiment.

FIG. 17 is an example of a cross-sectional view of the heater assembly of FIG. 4. FIG. 18 is an enlarged view illustrating a structure of the heater assembly of FIG. 4.

FIG. 19 is another example of a cross-sectional view of the heater assembly of FIG. 4.

FIG. 20 is a perspective view of a heater assembly according to another embodiment.

FIG. 21 is an example of a cross-sectional view of the heater assembly of FIG. 20.

FIG. 22 is another example of a cross-sectional view of the heater assembly of FIG. 20.

### MODE FOR INVENTION

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

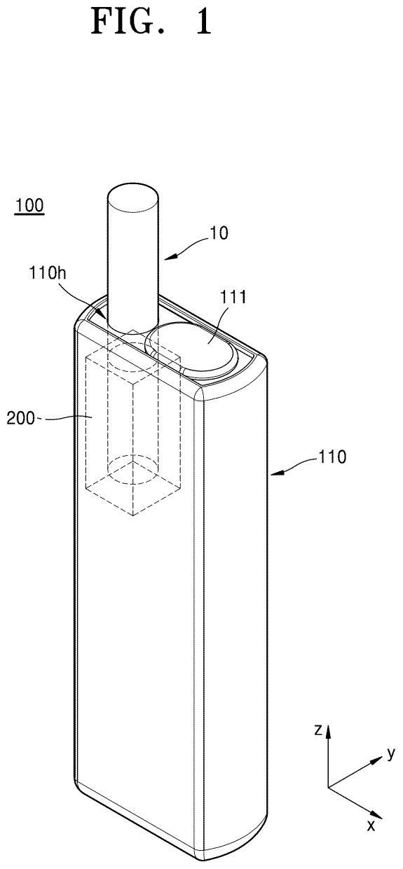

FIG. 1 is a perspective view of an aerosol generating device according to an embodiment.

Referring to FIG. 1, an aerosol generating device 100 according to an embodiment may include a housing 110 for accommodating an aerosol generating article 10 and a heater assembly 200 for heating the aerosol generating article 10 accommodated in the housing 110.

The housing 110 may form the overall exterior of the aerosol generating device 100, and components of the aerosol generating device 100 may be arranged in an inner space (or a ‘mounting space’) of the housing 110. For example, the heater assembly 200, a battery, a processor, and/or a sensor may be arranged in the inner space of the housing 110, but the components arranged in the inner space are not limited thereto.

An insertion hole 110h may be formed in a portion of the housing 110, and at least a portion of the aerosol generating article 10 may be inserted into the housing 110 through the insertion hole 110h. For example, the insertion hole 110h may be formed in a portion of an upper surface (e.g., a surface in a z direction) of the housing 110, but the position of the insertion hole 110h is not limited thereto. In another embodiment, the insertion hole 110h may be formed in a portion of a side surface (e.g., a surface in an x direction) of the housing 110.

The heater assembly 200 may be arranged in the inner space of the housing 110 and heat the aerosol generating article 10 inserted into or accommodated in the housing 110 through the insertion hole 110h. For example, the heater assembly 200 may be positioned to surround at least a portion of the aerosol generating article 10 inserted into or accommodated in the housing 110, thus heating the aerosol generating article 10.

According to an embodiment, the heater assembly 200 may heat the aerosol generating article 10 by using a dielectric heating method. In the present specification, the term ‘dielectric heating method’ refers to a method of heating a dielectric material, which is a heating object, by using resonance of microwaves and/or an electric field (which may include a magnetic field) of the microwaves. Microwaves are energy sources used to heat a heating object and are generated by high-frequency power, and thus, the term ‘microwave’ may hereinafter be used interchangeably with microwave power.

Charges or ions in a dielectric material included in the aerosol generating article 10 may vibrate or rotate because of microwave resonance within the heater assembly 200, and frictional heat generated during the vibration or rotation of the charges or ions may cause heat to be generated from the dielectric material such that the aerosol generating article 10 may be heated.

As the aerosol generating article 10 is heated by the heater assembly 200, an aerosol may be generated from the aerosol generating article 10. In the present specification, the term ‘aerosol’ may refer to gaseous particles generated from a mixture of vapor and air that are produced as the aerosol generating article 10 is heated.

The aerosol generated from the aerosol generating article 10 may pass through the aerosol generating article 10 or may be discharged to the outside of the aerosol generating device 100 through an empty space between the aerosol generating article 10 and the insertion hole 110h. A user may place their mouth on a portion of the aerosol generating article 10 exposed to the outside of the housing 110 and may inhale the aerosol discharged from the aerosol generating device 100, thereby smoking.

The aerosol generating device 100 according to an embodiment may further include a cover 111 that is movably arranged on the housing 110 to open or close the insertion hole 110h. For example, the cover 111 may be slidably coupled to the upper surface of the housing 110 and may expose the insertion hole 110h to the outside of the aerosol generating device 100 or cover the insertion hole 110h to prevent the same from being exposed to the outside of the aerosol generating device 100.

In an embodiment, the cover 111 may allow the insertion hole 110h to be exposed to the outside of the aerosol generating device 100 at a first position (or ‘open position’). When the aerosol generating device 100 is externally exposed, the aerosol generating article 10 may be inserted into the housing 110 through the insertion hole 110h.

In another embodiment, the cover 111 covers the insertion hole 110h at a second position (or ‘closed position’) to prevent the insertion hole 110h from being exposed outside the aerosol generating device 100. In this case, the cover 111 may prevent external foreign materials from entering the heater assembly 200 through the insertion hole 110h when the aerosol generating device 100 is not in use.

FIG. 1 only shows the aerosol generating device 100 for heating the aerosol generating article 10 in a solid state, but the aerosol generating device 100 is not limited thereto.

An aerosol generating device according to another embodiment may generate an aerosol by heating an aerosol generating material in a liquid or gel state by using the heater assembly 200, rather than heating the aerosol generating article 10 in a solid state.

An aerosol generating device according to another embodiment may include a heater assembly 200 that heats an aerosol generating article 10 and a cartridge (or ‘vaporizer’) that contains an aerosol generating material in a liquid or gel state and heats the same. After moving to the aerosol generating article 10 along an airflow passage connecting the cartridge and the aerosol generating article 10, the aerosol generated from the aerosol generating material may be mixed with the aerosol produced by the aerosol generating article 10 and then delivered to the user via the aerosol generating article 10.

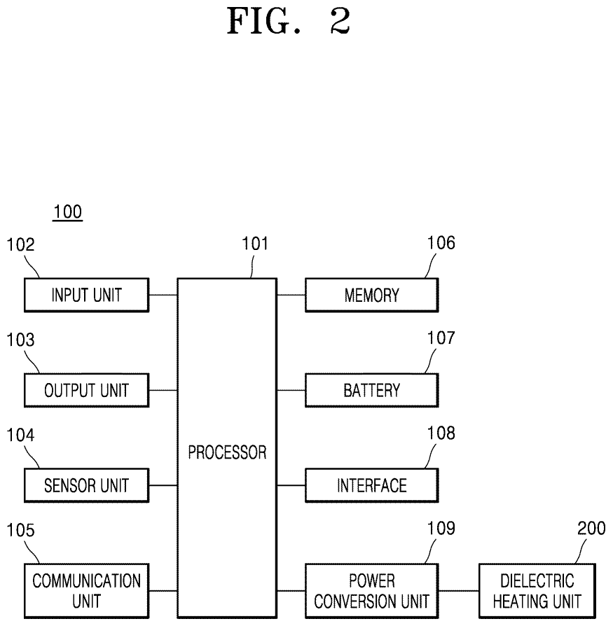

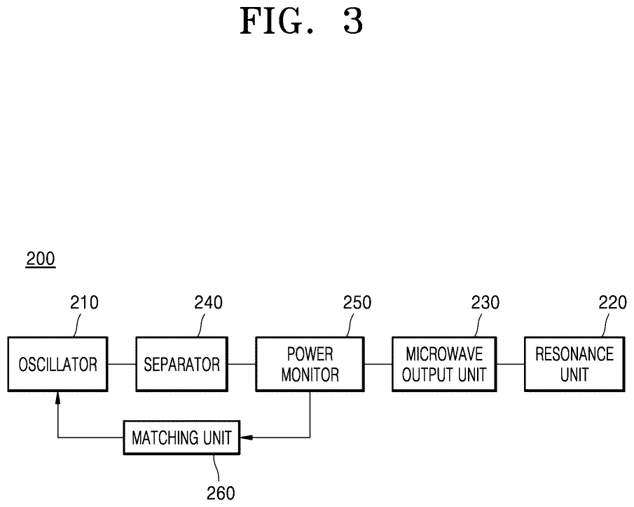

FIG. 2 is an internal block diagram of an aerosol generating device according to an embodiment.

Referring to FIG. 2, the aerosol generating device 100 may include an input unit 102, an output unit 103, a sensor unit 104, a communication unit 105, a memory 106, a battery 107, an interface unit 108, a power converter 109, and a dielectric heating unit 200. However, components of the aerosol generating device 100 are not limited to that illustrated in FIG. 2. Depending on design of the aerosol generating device 100, some of the components illustrated in FIG. 2 may be omitted or new component may be added.

The input unit 102 may receive a user input. For example, the input unit 102 may be a single pressure-type push button. As another example, the input unit 102 may be a touch panel including at least one touch sensor. The input unit 102 may transmit an input signal to a processor 101. The processor 101 may supply power to the dielectric heating unit 200 based on a user input or control the output unit 103 to output a user notification.

The output unit 103 may output information on a state of the aerosol generating device 100. The output unit 103 may output a charge/discharge state of the battery 107, a heating state of the dielectric heating unit 200, an insertion state of the aerosol generating article 10, and error information of the aerosol generating device 100. To this end, the output unit 103 may include a display, a haptic motor, and a sound output unit.

The sensor unit 104 may sense a state of the aerosol generating device 100 and a state around the aerosol generating device 100 and may transmit sensed information to the processor 101. Based on the sensed information, the processor 101 may control the aerosol generating device 100 to perform various functions, such as heating control of the dielectric heating unit 200, limiting smoking, determining whether the aerosol generating article 10 is inserted, and displaying a notification.

The sensor unit 104 may include a temperature sensor, a puff sensor, and an insertion detection sensor.

The temperature sensor may sense an internal temperature of the dielectric heating unit 200 in a non-contact manner or may contact the dielectric heating unit 200 to thus directly obtain a temperature of a resonator. According to an embodiment, the temperature sensor may also sense the temperature of the aerosol generating article 10. In addition, the temperature sensor may be arranged adjacent to the battery 107 and obtain the temperature thereof. The processor 101 may control the power supplied to the dielectric heating unit 200, based on temperature information of the temperature sensor.

The puff sensor may detect a user's puff. The puff sensor may sense a user's puff on the basis of at least one of a temperature change, a flow change, a power change, and a pressure change. The processor 101 may control the power supplied to the dielectric heating unit 200, based on puff information from the puff sensor. For example, the processor 101 may count the number of puffs, and when the number of puffs reaches a preset maximum number of puffs, the processor 101 may block the power supplied to the dielectric heating unit 200. As another example, the processor 101 may block the power supplied to the dielectric heating unit 200 when no puffs are sensed for a certain period of time.

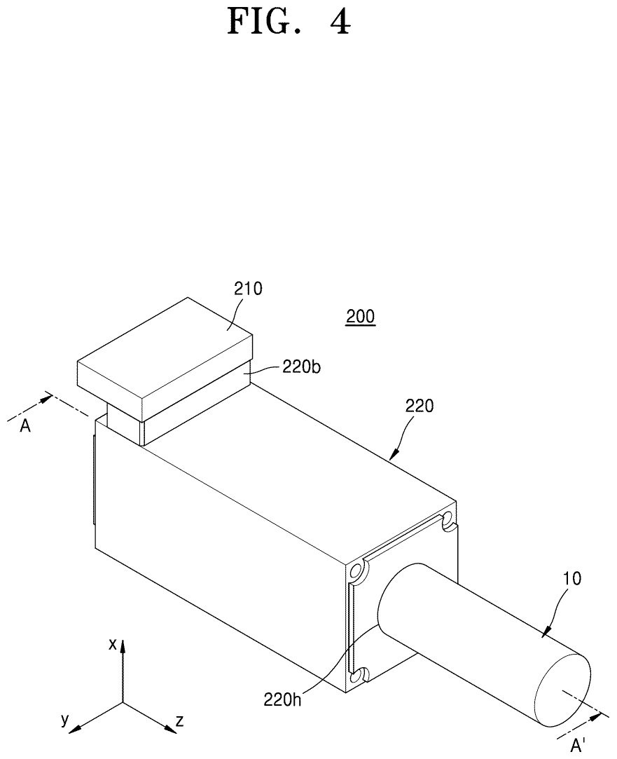

The insertion detection sensor may be arranged inside or adjacent to an accommodation space (220h of FIG. 4) and thus may detect the insertion and removal of the aerosol generating article 10 accommodated in the insertion hole 110h. For example, the insertion detection sensor may include an inductive sensor and/or a capacitance sensor. When the aerosol generating article 10 is inserted into the insertion hole 110h, the processor 101 may supply power to the dielectric heating unit 200.

According to an embodiment, the sensor unit 104 may additionally include a reuse detection sensor, a motion detection sensor, a humidity sensor, a barometric pressure sensor, a magnetic sensor, a cover detachment detection sensor, a location sensor (a global positioning system (GPS)), a proximity sensor, and the like. Because a function of each of sensors may be intuitively inferred from the name of the sensor, a detailed description thereof may be omitted.

The communication unit 105 may include at least one communication module for communication with external electronic device. The processor 101 may control the communication unit 105 and transmit information regarding the aerosol generating device 100 to the external electronic device. Alternatively, the processor 101 may receive information from the external electronic device through the communication unit 105 and control the components included in the aerosol generating device 100. For example, information exchanged between the communication unit 105 and the external electronic device may include user authentication information, firmware update information, and user's smoking pattern information.

The memory 106 may be a hardware component that stores various types of data processed in the aerosol generating device 100 and may store data processed and data to be processed by the processor 101. For example, the memory 106 may store an operation time of the aerosol generating device 100, the maximum number of puffs, the current number of puffs, at least one temperature profile, data on a user's smoking pattern, etc.

The battery 107 may supply power to the dielectric heating unit 200 to heat the aerosol generating article 10. In addition, the battery 107 may supply power required for operations of other components included in the aerosol generating device 100. The battery 107 may be a rechargeable battery or a separable and detachable battery.

The interface unit 108 may include a connection terminal that may be physically connected to the external electronic device. The connection terminal may include at least one of a High-Definition Multimedia Interface (HDMI) connector, a Universal Serial Bus (USB) connector, a Secure Digital (SD) card connector, and an audio connector (e.g., a headphone connector) or a combination thereof. The interface unit 108 may exchange information with the external electronic device through the connection terminal or charge power.

The power converter 109 may convert direct current power from the battery 107 into alternating current power. In addition, the power converter 109 may supply the converted alternating current power to the dielectric heating unit 200. The power converter 109 may be an inverter including at least one switching device, and the processor 101 may control the ON/OFF state of the switching device included in the power converter 109 and convert direct current power into alternating current power. The power converter 109 may be implemented as a full bridge or a half bridge.

The dielectric heating unit 200 may heat the aerosol generating article 10 by using a dielectric heating method. The dielectric heating unit 200 may correspond to the heater assembly 200 of FIG. 1.

The dielectric heating unit 200 may use microwaves and/or an electric field of microwaves (hereinafter, referred to as microwaves or microwave power when no classification is required) to heat the aerosol generating article 10. The heating method of the dielectric heating unit 200 may include heating a heating object by producing microwaves in a resonance structure, rather than radiating microwaves by using an antenna. The resonance structure is described below with reference to FIG. 4 and subsequent figures.

The dielectric heating unit 200 may output high-frequency microwaves to a resonating unit (220 of FIG. 3). Microwaves may be power in an Industrial Scientific and Medical (ISM) band allowed for heating, but one or more embodiments are not limited thereto. The resonating unit 220 may be designed by taking the wavelength of the microwaves into account to facilitate the resonance of the microwaves within the resonating unit 220.

The aerosol generating article 10 may be inserted into the resonating unit 220, and a dielectric material in the aerosol generating article 10 may be heated by the resonating unit 220. For example, the aerosol generating article 10 may include a polar substance, and molecules in the polar substance may be polarized in the resonating unit 220. The molecules may vibrate or rotate due to polarization, and the aerosol generating article 10 may be heated by frictional heat generated during the vibration or rotation. The dielectric heating unit 200 is described in more detail with reference to FIG. 3.

The processor 101 may control general operations of the aerosol generating device 100. The processor 101 may be implemented as an array of a plurality of logic gates or as a combination of a general-purpose microprocessor and a memory in which a program executable in the microprocessor is stored. Also, the processor 101 may be implemented in other forms of hardware.

The processor 101 may control direct current power supplied from the battery 107 to the power converter 109 and/or alternating current power supplied from the power converter 109 to the dielectric heating unit 200, according to power required for the dielectric heating unit 200. In an embodiment, the aerosol generating device 100 may include a converter that increases or decreases direct current power, and the processor 101 may control the converter to adjust the magnitude of the direct current power. Additionally, the processor 101 may adjust a switching frequency and a duty ratio of the switching device included in the power converter 109, thus controlling the alternating current power supplied to the dielectric heating unit 200.

The processor 101 may control microwave power of the dielectric heating unit 200 and a resonance frequency of the dielectric heating unit 200, thereby controlling a heating temperature of the aerosol generating article 10. Therefore, an oscillating unit 210, an isolation unit 240, a power monitoring unit 250, and a matching unit 260 of FIG. 3 described below may be some components of the processor 101.

The processor 101 may control microwave power of the dielectric heating unit 200 based on temperature profile information stored in the memory 106. In other words, a temperature profile may include information regarding a target temperature of the dielectric heating unit 200 over time, and the processor 101 may control the microwave power of the dielectric heating unit 200 over time.

The processor 101 may adjust the frequency of the microwaves to make the resonance frequency of the dielectric heating unit 200 uniform. The processor 101 may track a change in the resonance frequency of the dielectric heating unit 200 in real time as the heating object is heated, and may control the dielectric heating unit 200 to output a microwave frequency according to the changing resonance frequency. In other words, the processor 101 may adjust the microwave frequency in real time, irrespective of the temperature profile stored in advance.

FIG. 3 is an internal block diagram of the dielectric heating unit of FIG. 2.

Referring to FIG. 3, the dielectric heating unit 200 may include the oscillating unit 210, the isolation unit 240, the power monitoring unit 250, the matching unit 260, a microwave output unit 230, and the resonating unit 220. However, components of the dielectric heating unit 200 are not limited to that illustrated in FIG. 3. Depending on design of the dielectric heating unit 200, some of the components illustrated in FIG. 3 may be omitted or new component may be added.

The oscillating unit 210 may receive alternating current power from the power converter 109 and generate high-frequency microwave power. According to an embodiment, the power converter 109 may be included in the oscillating unit 210. Microwave power may be selected from the frequency bands, such as 915 MHz, 2.45 GHz, and 5.8 GHz, which are included in the ISM bands.

The oscillating unit 210 may include a solid-state-based RF generating device and generate microwave power by using the same. The solid-state-based RF generating device may be realized as a semiconductor. When the oscillating unit 210 is implemented as a semiconductor, the dielectric heating unit 200 may be miniaturized, and the lifespan of the device may be extended.

The oscillating unit 210 may output microwave power to the resonating unit 220. The oscillating unit 210 may include a power amplifier that increases or decreases the microwave power, and the power amplifier may adjust the magnitude of the microwave power under the control by the processor 101. For example, the power amplifier may decrease or increase the amplitude of microwaves. As the amplitude of microwaves is adjusted, the microwave power may also be adjusted.

The processor 101 may adjust the magnitude of the microwave power output from the oscillating unit 210, based on the temperature profile stored in advance. For example, the temperature profile may include target temperature information according to the preheating section and the smoking section, and the oscillating unit 210 may supply microwave power at a first power level in the preheating section and supply microwave power at a second power level in the smoking section, wherein the second power level is less than the first power level.

The isolation unit 240 may block the microwave power that is input to the oscillating unit 210 from the resonating unit 220. Most of the microwave power that is output from the oscillating unit 210 is absorbed into the heating object, but depending on the heating characteristics of the heating object, part of the microwave power may be reflected from the heating object and transmitted back towards the oscillating unit 210. This occurs due to a change in the impedance measured from the oscillating unit 210 to the resonating unit 220 as polar molecules are depleted while the heating object is heated. The description that ‘the impedance from the oscillating unit 210 to the resonating unit 220 changes’ may be the same as the description that ‘the resonance frequency of the resonating unit 220 changes.’ When the microwave power reflected from the resonating unit 220 is input to the oscillating unit 210, the oscillating unit 210 may not only malfunction but also fail to achieve expected output performance. The isolation unit 240 may not redirect the microwave power, which is reflected from the resonating unit 220, to the oscillating unit 210 and may guide the microwave power in a certain direction to absorb the same. To this end, the isolation unit 240 may include a circulator and a dummy load. The power monitoring unit 250 may monitor the microwave power, which is output from the oscillating unit 210, and the reflected microwave power, which is reflected from the resonating unit 220, respectively. The power monitoring unit 250 may transmit information regarding the microwave power and the reflected microwave power to the matching unit 260.

The matching unit 260 may match the impedance measured from the oscillating unit 210 to the resonating unit 220 with the impedance measured from the resonating unit 220 to the oscillating unit 210 to minimize the reflected microwave power. Impedance matching may indicate that the frequency of the oscillating unit 210 aligns with the resonance frequency of the resonating unit 220. Therefore, the matching unit 260 may vary the frequency of the oscillating unit 210 to match the impedance. In other words, the matching unit 260 may adjust the frequency of the microwave power that is output from the oscillating unit 210 to minimize the reflected microwave power. The impedance matching by the matching unit 260 may be performed in real time regardless of the temperature profile.

The oscillating unit 210, the isolation unit 240, the power monitoring unit 250, and the matching unit 260 described above may be distinct from the microwave output unit 230 and the resonating unit 220 below and may be implemented as microwave sources in the form of chips. According to an embodiment, the oscillating unit 210, the isolation unit 240, the power monitoring unit 250, and the matching unit 260 may be implemented as some components of the processor 101.

The microwave output unit 230 may be a component configured to input the microwave power to the resonating unit 220 and may correspond to a coupler shown in FIG. 3 and subsequent figures. The microwave output unit 230 may be implemented in the form of SubMiniature version A (SMA), SubMiniature version B (SMB), Micro Coaxial (MCX), and Micro-Miniature coaxial (MMCX) connectors. The microwave output unit 230 may connect the resonating unit 220 to a chip-shaped microwave source and deliver microwave power generated from the microwave source to the resonating unit 220.

The resonating unit 220 may form microwaves within the resonance structure, thus heating the heating object. The resonating unit 220 may include an accommodation space where the aerosol generating article 10 is accommodated, and the aerosol generating article 10 may be exposed to microwaves and dielectric-heated. For example, the aerosol generating article 10 may include a polar substance, and molecules in the polar substance may be polarized by the microwaves within the resonating unit 220. The molecules may vibrate or rotate due to polarization, and the aerosol generating article 10 may be heated by frictional heat generated during the vibration or rotation.

The resonating unit 220 may include at least one internal conductor to resonate microwaves, and depending on the arrangement, thickness, length, and the like of the internal conductor, the microwaves may resonate within the resonating unit 220.

The resonating unit 220 may be designed by taking the wavelength of the microwaves into account to facilitate the resonance of the microwaves within the resonating unit 220. For the resonance of the microwaves within the resonating unit 220, there is a need for a closed end/short end with a closed cross-section and an open end with at least one open portion on the opposite side. In addition, the length between the closed end/short end and the open end must be set to an integer multiple of ¼ of the microwave wavelength. The resonating unit 220 selects a length equal to ¼ of the microwave wavelength to ensure device miniaturization. In other words, the length between the closed end/short end and the open end of the resonating unit 220 may be set to ¼ of the microwave wavelength.

The resonating unit 220 may include a dielectric accommodation space. The dielectric accommodation space is separate from the accommodation space of the aerosol generating article 10 and contains a material that may reduce the size of the resonating unit 220 by changing the overall resonance frequency of the resonating unit 220. In an embodiment, dielectric materials with low microwave absorption may be accommodated in the dielectric accommodation space. Such accommodation is intended to prevent energy, which should be delivered to the heating object, from being transferred to the dielectric materials and causing the dielectric materials to generate heat. Microwave absorbance may be expressed as a loss tangent that is a ratio of a real part of a complex dielectric constant to an imaginary part thereof. In an embodiment, dielectric materials with a loss tangent of a preset value or less may be accommodated in the dielectric accommodation space 227, and the preset value may be 1/100. For example, the dielectric material may include at least any one of quartz, tetrafluoroethylene, and aluminum oxide, or a combination thereof, but one or more embodiments are not limited thereto.

FIG. 4 is a perspective view of a heater assembly according to an embodiment.

Referring to FIG. 4, the heater assembly 200 according to an embodiment may include the oscillating unit 210 and the resonating unit 220. FIG. 4 may show an embodiment of the heater assembly 200 and the dielectric heating unit 200 described above, and repeated description is omitted.

The oscillating unit 210 may generate microwaves in a designated frequency band as power is supplied. The microwaves generated by the oscillating unit 210 may be transferred to the resonating unit 220 through a coupler (not shown).

The resonating unit 220 may include the accommodation space 220h for accommodating at least a portion of the aerosol generating article 10 and resonate the microwaves generated by the oscillating unit 210, thus heating the aerosol generating article 10 by using the dielectric heating method. For example, charges of glycerin included in the aerosol generating article 10 may vibrate or rotate due to the resonance of the microwaves, and frictional heat generated during such vibration or rotation may cause heat to be produced in the glycerin such that aerosol generating article 10 may be heated.

According to an embodiment, the resonating unit 220 may include a material with low microwave absorption to prevent the microwaves, generated by the oscillating unit 210, from being absorbed into the resonating unit 220.

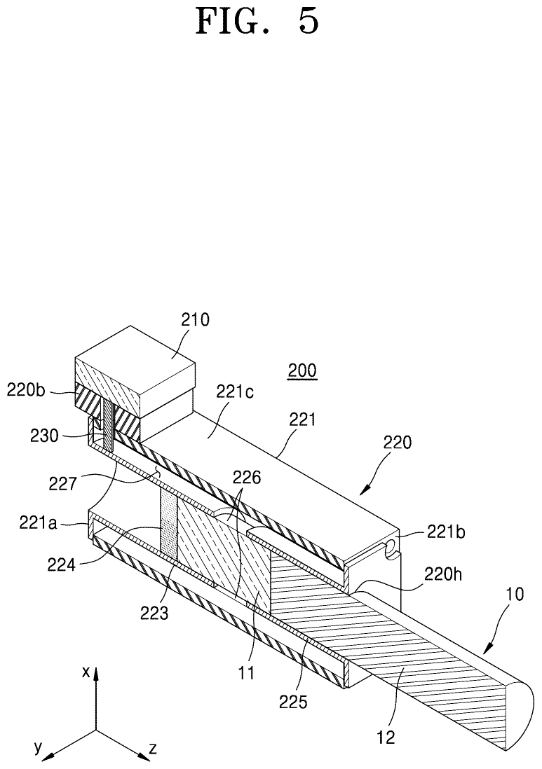

Hereinafter, the detailed structure of the resonating unit 220 of the heater assembly 200 is described with reference to FIG. 5.

FIG. 5 is a cross-sectional view of the heater assembly of FIG. 4. FIG. 5 shows a cross-section of the heater assembly 200 of FIG. 4, taken along a direction A-A′.

Referring to FIG. 5, the heater assembly 200 according to an embodiment may include the oscillating unit 210, the resonating unit 220, and a coupler 230. The components of the heater assembly 200 may be the same as or similar to at least one of the components of the heater assembly 200 of FIG. 4, and repeated description is omitted hereinafter.

The oscillating unit 210 may generate microwaves in a designated frequency band as an alternating current voltage is applied, and the microwaves generated by the oscillating unit 210 may be delivered to the resonating unit 220 through the coupler 230.

According to an embodiment, the oscillating unit 210 may be fixed to the resonating unit 220 to prevent separation from the resonating unit 220 while the aerosol generating device is used. In an embodiment, the oscillating unit 210 may be supported by brackets 220b protruding along the x direction on a portion of the resonating unit 220, thus being fixed to the resonating unit 220. In another embodiment, the oscillating unit 210 may be fixed to a portion of the resonating unit 220 without the brackets 220b.

In the drawing, the oscillating unit 210 is fixed to a portion of the resonating unit 220 that faces the x direction, but the position of the oscillating unit 210 is not limited thereto. In another embodiment, the oscillating unit 210 may be fixed to another portion of the resonating unit 220 that faces in the −z direction.

The resonating unit 220 may be arranged to surround at least a portion of the aerosol generating article 10 inserted into the aerosol generating device and may heat the aerosol generating article 10 by using the microwaves generated by the oscillating unit 210. For example, dielectric materials included in the aerosol generating article 10 may generate heat because of the electric field generated in the resonating unit 220 due to the microwaves, and the aerosol generating article 10 may be heated by the heat generated in the dielectric materials.

According to an embodiment, the aerosol generating article 10 may include a tobacco rod 11 and a filter rod 12.

The tobacco rod 11 may include an aerosol generating material and may be formed as a sheet, a strand, or a pipe tobacco formed of tiny bits cut from a tobacco sheet. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 11 may include other additives, such as flavors, a wetting agent, and/or organic acid. Also, the tobacco rod 11 may include a flavored liquid, such as menthol or a moisturizer, which is injected to the tobacco rod 11.

The filter rod 12 may include a cellulose acetate filter. Shapes of the filter rod 12 are not limited. For example, the filter rod 12 may include a cylinder-type rod or a tube-type rod having a hollow inside. Also, the filter rod 12 may include a recess-type rod. When the filter rod 12 includes a plurality of segments, at least one of the plurality of segments may have a different shape.

At least part (e.g., glycerin) of the aerosol generating material included in the aerosol generating article 10 may be a dielectric material with polarity in an electric field, and the at least part of the aerosol generating material may generate heat in a dielectric heating method, thereby heating the aerosol generating article 10.

According to an embodiment, the resonating unit 220 may include an outer conductor 221, a first internal conductor 223, and a second internal conductor 225.

The outer conductor 221 may form the overall exterior of the resonating unit 220 and have a shape with a hollow space therein; thus, the components of the resonating unit 220 may be arranged inside the outer conductor 221. The outer conductor 221 may include the accommodation space 220h where the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b facing the first surface 221a, and side surfaces 221c surrounding an empty space between the first surface 221a and the second surface 221b. At least a portion (e.g., the first internal conductor 223 and the second internal conductor 225) of the components of the resonating unit 220 may be arranged in the inner space of the resonating unit 220 formed by the first surface 221a, the second surface 221b, and the side surfaces 221c.

The first internal conductor 223 may be shaped as a hollow cylinder extending in a direction towards the inner space of the outer conductor 221 from the first surface 221a of the outer conductor 221.

According to an embodiment, a portion of the first internal conductor 223 may contact the coupler 230 connected to the oscillating unit 210, and the microwaves generated by the oscillating unit 210 may be transferred to the first internal conductor 223 through the coupler 230. For example, the coupler 230 may penetrate the outer conductor 221 and may be arranged so that one end of the coupler 230 contacts the oscillating unit 210 and the other end contacts a portion of the first internal conductor 223, and the microwaves generated by the oscillating unit 210 may be transferred to the first internal conductor 223 through the coupler 230.

In this case, the coupler 230 may be arranged not to contact the outer conductor 221 but to penetrate the same to transfer the microwaves, but the arrangement of the coupler 230 is not limited thereto as long as the microwaves generated by the oscillating unit 210 may be delivered to the first internal conductor 223.

A first area formed between the outer conductor 221 and the first internal conductor 223 may function as a ‘first resonator’ that generates an electric field through microwave resonance. The first area may refer to the space formed by the first surface 221a and the side surfaces 221c of the outer conductor 221 and the first internal conductor 223, and within the first area, an electric field may be generated as the microwaves transmitted through the coupler 230 resonate. The second internal conductor 225 may be shaped as a hollow cylinder extending in a direction towards the inner space of the outer conductor 221 from the second surface 221b of the outer conductor 221. The second internal conductor 225 may be spaced apart from the first internal conductor 223 by a certain distance within the inner space of the outer conductor 221, and there may be a gap between the first internal conductor 223 and the second internal conductor 225.

A second area formed between the outer conductor 221 and the second internal conductor 225 may function as a ‘second resonator’ that generates an electric field through microwave resonance. The second internal conductor 225 may be coupled to the first internal conductor 223 (e.g., capacitive coupling), and when an electric field is generated in the first area because of the above coupling relationship, an induced electric field may be generated even in the second area. In the present specification, the term ‘capacitive coupling’ may refer to a coupling relationship in which energy may be transferred due to capacitance between two conductors.

For example, as the microwaves generated by the oscillating unit 210 are delivered to the first internal conductor 223, an electric field may be generated in the first area due to resonance, and an induced electric field may be generated in the second area that is formed by the second internal conductor 225 coupled to the outer conductor 221 and the first internal conductor 223.

According to an embodiment, the first area and the second area of the resonating unit 220 may operate as resonators with a length equal to a quarter of the microwave wavelength λ.

In an embodiment, one end of the first area (e.g., an end in the −z direction) may be formed as a closed end/short end as the cross-section of the first area is closed by the first surface 221a of the outer conductor 221, and the other end of the first area (e.g., an end in the z direction) may be formed as an open end because the first surface 221a is not present, leaving the cross-section open. As another example, one end of the second area (e.g., an end in the −z direction) may be formed as an open end as the cross-section is open, and the other end of the second area (e.g., an end in the z direction) may be formed as a closed end/short end as the cross-section of the second area is closed by the second surface 221b of the outer conductor 221.

In other words, when viewed in an xz plane, the first area and the second area may each include a closed end/short end and an open end and may be shaped overall in the form of “ [symbol] ”, and based on the above-described structure, the first area and the second area may each function as a resonator with a length of a quarter of the microwave wavelength.

According to an embodiment, the first internal conductor 223 and the second internal conductor 225 are formed to have the same length with respect to the z axis, and thus, the first area and the second area may be symmetrically arranged; however, one or more embodiments are not limited thereto.

The aerosol generating article 10 inserted into the inner space of the outer conductor 221 through the accommodation space 220h may be surrounded by the first internal conductor 223 and the second internal conductor 225 and may be heated by using a dielectric heating method.

At least a portion of the electric field, which is generated in the first area and/or the second area due to microwave resonance, may propagate towards the inside of the first internal conductor 223 and/or the second internal conductor 225 through the gap 226 between the first internal conductor 223 and/or the second internal conductor 225, and the aerosol generating article 10 surrounded by the first internal conductor 223 and the second internal conductor 225 may be heated by the propagating electric field. For example, dielectric materials included in the aerosol generating article 10 may generate heat because of the electric field propagating through the gap 226, and the aerosol generating article 10 may be heated by the heat generated in the dielectric materials.

The heater assembly 200 according to an embodiment may be designed such that the diameters first internal conductor 223 and the second internal conductor 225 may each fall below a designated value, thereby preventing the electric field, which propagates into the first internal conductor 223 and/or the second internal conductor 225, from leaking to the outside of the heater assembly 200 or the resonating unit 220.

In the present specification, the term ‘designated value’ may refer to a diameter value at which the electric field starts leaking to the outside of the first internal conductor 223 and/or the second internal conductor 225. For example, when the diameter of the first internal conductor 223 and/or the second internal conductor 225 has a designated value or more, part of the electric field entering the first internal conductor 223 and/or the second internal conductor 225 may leak to the outside of the resonating unit 220.

On the contrary, the heater assembly 200 according to an embodiment may prevent the electric field from propagating to the outside of the resonating unit 220 according to the structure in which the diameters of the first internal conductor 223 and the second internal conductor 225 are less than the designated value, thereby preventing the electric field from leaking to the outside of the heater assembly 200 or the resonating unit 220 without a separate blocking member.

According to an embodiment, when the aerosol generating article 10 is inserted into the resonating unit 220 through the accommodation space 220h, the tobacco rod 11 of the aerosol generating article 10 may be arranged at a position corresponding to the gap 226 between the first internal conductor 223 and the second internal conductor 225.

As the electric field generated in the first area and the electric field generated in the second area are introduced to the first internal conductor 223 and/or the second internal conductor 225 through the gap 226, the strongest electric field may be generated in a peripheral area of the gap 226 within the inner area of the resonating unit 220. In the heater assembly 200 according to an embodiment, the tobacco rod 11 including dielectric materials generating heat due to the electric field is arranged at the position corresponding to the gap 226 where the electric field is the strongest, and thus, the heating efficiency (or ‘dielectric heating efficiency’) of the heater assembly 200 may be improved.

According to an embodiment, the resonating unit 220 may further include a closing unit 224 that is located inside the first internal conductor 223, closes a cross-section of the first internal conductor 223, and restricts a flow direction of the aerosol generated from the aerosol generating article 10. For example, the closing unit 224 may block the flow of the aerosol, which is generated from the aerosol generating article 10, in the −z direction by closing the cross-section of the first internal conductor 223.

When the aerosol generated from the aerosol generating article 10 or droplets, which are generated as the aerosol is liquefied, flow in the −z direction and enter other components of the aerosol generating device (e.g., the aerosol generating device 100 of FIG. 1), malfunction or damage to the components of the aerosol generating device may occur. On the contrary, the heater assembly 200 according to an embodiment restricts the flow direction of the aerosol by using the closing unit 224, thereby preventing malfunction or damage to the components of the aerosol generating device that is caused by the aerosol or droplets.

According to an embodiment, the resonating unit 220 may further include the dielectric accommodation space 227 for accommodating dielectric materials. The dielectric accommodation space 227 may refer to an empty space between the outer conductor 221, the first internal conductor 223, and the second internal conductor 225, and dielectric materials with low microwave absorption may be accommodated in the dielectric accommodation space 227. For example, the dielectric material may include at least any one of quartz, tetrafluoroethylene, and aluminum oxide, or a combination thereof, but one or more embodiments are not limited thereto.

In the heater assembly 200 according to an embodiment, the dielectric materials may be arranged in the dielectric accommodation space 227, and thus, an electric field such as the resonating unit 220 without dielectric materials may be generated while reducing the overall size of the resonating unit 220. That is, in the heater assembly 200 according to an embodiment, the size of the resonating unit 220 may be reduced by using the dielectric materials arranged in the dielectric accommodation space 227 to decrease the mounting space required for the resonating unit 220 in the aerosol generating device, resulting in the miniaturization of the aerosol generating device.

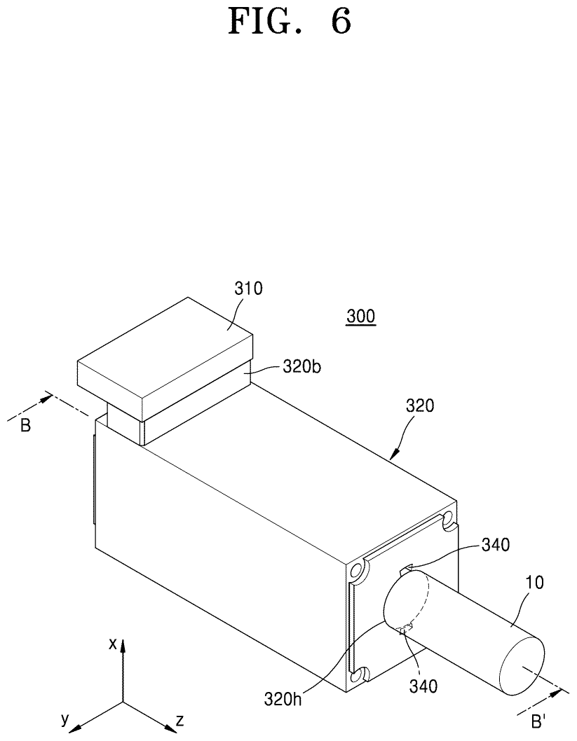

FIG. 6 is a perspective view of a heater assembly 300 according to another embodiment.

Referring to FIG. 6, the heater assembly 300 according to another embodiment may include an oscillator 310 (for example, the oscillator 210 of FIG. 4), a resonance unit 320 (for example, the resonance unit 220 of FIG. 4), and an airflow passage 340. The heater assembly 300 according to another embodiment may be an assembly in which the airflow passage 340 is added to the heater assembly 200 of FIG. 4, and accordingly, redundant descriptions thereof are omitted below.

The oscillator 310 may generate microwaves in a designated frequency band as power is supplied. Microwaves generated by the oscillator 310 may be transmitted to the resonance unit 320 through a coupler connecting the oscillator 310 to the resonance unit 320.

The resonance unit 320 may include an accommodation space 320h (for example, the accommodation space 220h of FIG. 4) for accommodating at least a part of an aerosol generating article 10 and may heat the aerosol generating article 10 by a using a dielectric heating method by resonating the microwaves generated by the oscillator 310. For example, electric charges of a dielectric (for example, glycerin) included in the aerosol generating article 10 accommodated inside the resonance unit 320 may vibrate or rotate due to resonance of microwaves, and the frictional heat generated when the electric charges vibrate or rotate may generate heat in the dielectric, and accordingly, the aerosol generating article 10 may be heated.

The airflow passage 340 may guide a direction of air movement such that air (hereinafter, “external air”) outside the heater assembly 300 or the resonance unit 320 is introduced into the aerosol generating article 10 accommodated in the accommodation space 320h. For example, the airflow passage 340 may be arranged to connect the outside of the resonance unit 320 to the accommodation space 320h in one region of the resonance unit 320, and the external air may move along the airflow passage 340 to be introduced into the aerosol generating article 10 accommodated in the accommodation space 320h. As the external air introduced into the aerosol generating article 10 is mixed with the vapor generated as the aerosol generating article 10 is heated, an aerosol may be generated, and the generated aerosol may pass through the aerosol generating article 10 to be discharged to the outside of the heater assembly 300.

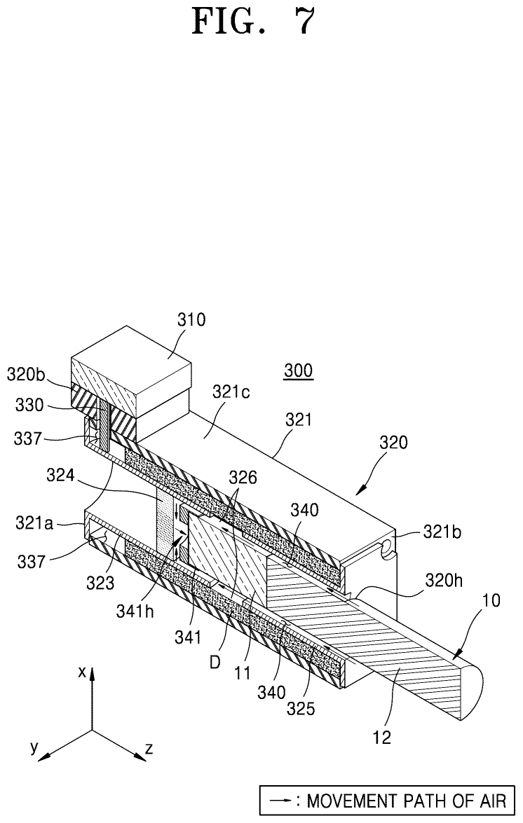

Hereinafter, an arrangement structure of the airflow passage 340 for introducing external air into the accommodation space 320h is specifically described with reference to FIG. 7.

FIG. 7 is a cross-sectional view of the heater assembly 300 of FIG. 6. FIG. 7 illustrates a cross-section of the heater assembly 300 of FIG. 6 taken along line B-B′, and arrows in FIG. 7 indicate movement paths of air (or “external air”).

Referring to FIG. 7, the heater assembly 300 according to another embodiment may include the oscillator 310 (for example the oscillator 210 of FIG. 5), the resonance unit 320 (for example the resonance unit 220 of FIG. 5), a coupler 330 (for example, the coupler 230 of FIG. 5), and the airflow passage 340.

The oscillator 310 may generate microwaves in a designated frequency band when an alternating current (AC) voltage is applied, and the microwaves generated by the oscillator 310 may be transmitted to the resonance unit 320 through the coupler 330.

The resonance unit 320 may surround at least a part of an aerosol generating article 10 inserted into an aerosol generating device (for example, the aerosol generating device 100 of FIG. 1) and may heat the aerosol generating article 10 with the microwaves generated by the oscillator 310. For example, dielectrics included in the aerosol generating article 10 may generate heat by an electric field generated inside the resonance unit 320 by resonance of microwaves, and the aerosol generating article 10 may be heated by the heat generated from the dielectrics.

According to one embodiment, the resonance unit 320 may include an outer conductor 321, a first inner conductor 323, and a second inner conductor 325.

The outer conductor 321 may form the entire appearance of the resonance unit 320 and has an inner portion formed in a hollow shape such that components of the resonance unit 320 may be arranged inside the outer conductor 321. The outer conductor 321 may include the accommodation space 320h in which at least one region of an aerosol generating article 10 may be inserted into the outer conductor 321. The accommodation space 320h may indicate a space formed by the first inner conductor 323 and/or the second inner conductor 325 arranged inside the outer conductor 321 and capable of accommodating an aerosol generating article 10 inserted into the outer conductor 321.

According to one embodiment, the outer conductor 321 may have a first surface 321a, a second surface 321b facing the first surface 321a, and a side surface 321c surrounding a free space between the first surface 321a and the second surface 321b. At least some (for example, the first inner conductor 323 and the second inner conductor 325) of components of the resonance unit 320 may be arranged in an inner space of the resonance unit 320 formed by the first surface 321a, the second surface 321b, and the side surface 321c.

The first inner conductor 323 may be formed in a hollow cylindrical shape extending from the first surface 321a of the outer conductor 321 along a direction facing an inner space of the outer conductor 321 or along a longitudinal direction of the outer conductor 321.

According to one embodiment, one region of the first inner conductor 323 may be in contact with the coupler 330 connected to the oscillator 310, and the microwaves generated by the oscillator 310 may be transmitted to the first inner conductor 323 through the coupler 330. For example, the coupler 330 may pass through the outer conductor 321 and has one end in contact with the oscillator 310 and the other end in contact with one region of the first inner conductor 323, and the microwaves generated by the oscillator 310 may be transmitted to the first inner conductor 323 through the coupler 330.

In this case, the coupler 330 may pass through the outer conductor 321 without being in contact with the outer conductor 321 to transfer the microwave, but when the microwaves generated by the oscillator 310 may be transmitted to the first inner conductor 323, the arrangement structure of the coupler 330 is not limited thereto.

A first region formed between the outer conductor 321 and the first inner conductor 323 may operate as a “first resonator” that generates an electric field according to resonance of microwaves. The first region may refer to a space formed by the first surface 321a, the side surface 321c of the outer conductor 321, and the first inner conductor 323, and an electric field may be generated in the first region by resonance of microwaves transmitted through the coupler 330. The second inner conductor 325 may be formed in a hollow cylindrical shape extending from the second surface 321b of the outer conductor 321 along a direction facing an inner space of the outer conductor 321 or along a longitudinal direction of the outer conductor 321. The second inner conductor 325 may be separated from the first inner conductor 323 by a preset distance in an inner space of the outer conductor 321, and a gap 326 may be formed between the first inner conductor 323 and the second inner conductor 325.

A second region formed between the outer conductor 321 and the second inner conductor 325 may operate as a “second resonator” that generates an electric field according to resonance of microwaves. The second inner conductor 325 may be coupled (capacitively coupled) with the first inner conductor 323, and when an electric field is generated in the first region by a coupling relationship described above, an induced electric field may also be generated in the second region.

For example, when a microwave generated by the oscillator 310 is transmitted to the first inner conductor 323, an electric field may be generated in the first region by resonance, and an induced electric field may be generated in the second region formed by the second inner conductor 325 coupled with the outer conductor 321 and the first inner conductor 323.

According to one embodiment, the first region and the second region of the resonance unit 320 may operate as a resonator having a length of ¼ wavelength (λ) of a microwave.

In one example, one end (for example, one end in the −z direction) of the first region may be formed as a closed end (a short end) as a cross-section of the first region is closed by the first surface 321a of the outer conductor 321, and the other end (for example, an end in the z direction) of the first region may be formed as an open end as a cross-section is opened because the first surface 321a is not arranged. In another example, one end (for example, one end in the −z direction) of the second region may be formed as an open end as a cross-section is opened, and the other end (for example, one end in the z direction) of the second region may be formed as a closed end as a cross-section of the second region is closed by the second surface 321b of the outer conductor 321.

That is, the entire shape of each of the first region and the second region, which includes the closed end and the open end, may be formed in a “ [symbol] ” shape when viewed on an xz plane, and through the above-described structure, the first region and the second region may operate as a resonator having a ¼ wavelength length of a microwave.

According to one embodiment, the first inner conductor 323 and the second inner conductor 325 may be formed to have the same length based on a z axis, such that the first region and the second region may be arranged symmetrically to each other, but the present disclosure is not limited thereto. The aerosol generating article 10 inserted into an inner space of the outer conductor 321 through the accommodation space 320h may be surrounded by the first inner conductor 323 and the second inner conductor 325 and heated by a dielectric heating method.

At least a part of an electric field generated by resonance of microwaves in the first region and/or the second region may be propagated into the first inner conductor 323 and/or the second inner conductor 325 through the gap 326 between the first inner conductor 323 and the second inner conductor 325, and the aerosol generating article 10 surrounded by the first inner conductor 323 and the second inner conductor 325 may be heated by the electric field propagated into the first inner conductor 323 and/or the second inner conductor 325. For example, a dielectric included in the aerosol generating article 10 may be heated by the electric field propagated through the gap 326, and the aerosol generating article 10 may be heated by the heat generated from the dielectric.

The heater assembly 300 according to another embodiment may prevent an electric field transferred into the first inner conductor 323 and/or the second inner conductor 325 from leaking to the outside of the heater assembly 300 or the resonance unit 320 when diameters of the first inner conductor 323 and the second inner conductor 325 are less than a designated value.

In the present disclosure, the “designated value” may indicate a diameter value at which an electric field begins to leak to the outside of the first inner conductor 323 and/or the second inner conductor 325. For example, when a diameter of the first inner conductor 323 and/or a diameter of the second inner conductor 325 is greater than a designated value, a part of the electric field introduced into the first inner conductor 323 and/or the second inner conductor 325 may leak to the outside of the resonance unit 320.

In addition, the heater assembly 300 according to another embodiment may prevent an electric field from being transferred to the outside of the resonance unit 320 through a structure in which diameters of the first inner conductor 323 and the second inner conductor 325 are less than a designated value, and as a result, the electric field may be prevented from leaking to the outside of the heater assembly 300 or the resonance unit 320 without a separate shielding member.

According to one embodiment, the resonance unit 320 may further include a closing unit 324 placed inside the first internal conductor 323 and closing a cross-section of the first internal conductor 323 to limit a flow direction of an aerosol generated from the aerosol generating article 10. For example, the closing unit 324 may close a cross-section of the first internal conductor 323 to block flowing of an aerosol, which is generated from the aerosol generating article 10, in the −z direction.

When the aerosol generated from the aerosol generating article 10 or the droplets generated as the aerosol is liquefied flows in the −z direction to introduce into another component of the aerosol generating device (for example, the aerosol generating device 100 of FIG. 1), components of the aerosol generating device may be malfunctioned or damaged. In addition, the heater assembly 300 according to another embodiment may prevent malfunction or damage of components of the aerosol generating device due to an aerosol or droplets by limiting a flow direction of the aerosol through the closing unit 324.

According to one embodiment, the resonance unit 320 may further include a dielectric accommodation space 337 and a dielectric D accommodated in the dielectric accommodation space 337 to adjust a dielectric constant of the resonance unit 320.

The dielectric accommodation space 337 may indicate a free space formed between the outer conductor 321 and the first inner conductor 323 and the second inner conductor 325, and the dielectric D may be accommodated in the dielectric accommodation space 337. For example, the dielectric D may be at least one of quartz with low microwave absorption, tetrafluoroethylene, and aluminum oxide, or a combination thereof, but the type of the dielectric D is not limited thereto.

In the heater assembly 300 according to another embodiment, by arranging the dielectric D inside the dielectric accommodation space 337, the entire size of the resonance unit 320 may be reduced, and an electric field identical to the electrical field generated by the resonance unit 320 that does not include a dielectric may be generated. That is, in the heater assembly 300 according to another embodiment, a size of the resonance unit 320 may be reduced by the dielectric D arranged inside the dielectric accommodation space 337, and accordingly, an accommodation space of the resonance unit 320 in the aerosol generating device may be reduced, and as a result, the aerosol generating device (for example, the aerosol generating device 100 of FIG. 1) may be reduced in size.

According to one embodiment, when the aerosol generating article 10 is inserted into the resonance unit 320 through the accommodation space 320h, a tobacco rod 11 of the aerosol generating article 10 may be arranged at a position corresponding to the gap 326 between the first inner conductor 323 and the second inner conductor 325.

As an electric field generated in the first region and an electric field generated in the second region are introduced into the first inner conductor 323 and/or the second inner conductor 325 through the gap 326, the strongest electric field may be generated in a peripheral region of the gap 326 among the inner regions of the resonance unit 320. In the heater assembly 300 according to another embodiment, by arranging the tobacco rod 11 including a dielectric for generating heat by using an electric field at a position corresponding to the gap 326 where the electric field is strongest, the heating efficiency of the heater assembly 300 may be increased.

The airflow passage 340 is formed inside the first inner conductor 323 and the second inner conductor 325 of the resonance unit 320 and may form a path for allowing external air to be introduced into the aerosol generating article 10 accommodated in the accommodation space 320h. For example, the airflow passage 340 may be formed in a space between the first internal conductor 323 and the second internal conductor 325 and the aerosol generating article 10 accommodated in the accommodation space 320h, and may be a flow path connecting the outside of the resonance unit 320 and the aerosol generating article 10 accommodated in the accommodation space 320h.

The airflow passage 340 may be arranged such that the external air moves in a longitudinal direction (for example, the −z direction) of the accommodation space 320h and then introduces into one end (for example, one end in the −z direction) of the aerosol generating article 10 accommodated in the accommodation space 320h. That is, the airflow passage 340 may have one region extending in a longitudinal direction of the accommodation space 320h and another region extending in a direction crossing a longitudinal direction of the accommodation space 320h to connect the one region of the airflow passage 340 to the inside of the accommodation space 320h.

The external air introduced into one end of the aerosol generating article 10 through the airflow passage 340 may be mixed with the vapor generated as the aerosol generating article 10 is heated to generate an aerosol, and the generated aerosol may pass through the aerosol generating article 10 to be discharged to the outside of the heater assembly 300.

As the external air moves between the aerosol generating article 10 and the first internal conductor 323 and the second internal conductor 325 that operate as a resonator through the airflow passage 340 described above, the heat generated from the aerosol generating article 10 may be prevented from being transferred to the first internal conductor 323 and the second internal conductor 325 through the external air. As a result, the heater assembly 300 according to another embodiment may increase the entire insulation performance of the resonance unit 320 through the airflow passage 340 described above.

In addition, the external air is heated by the heat generated by the aerosol generating article 10 in a process of moving along the airflow passage 340, and accordingly, the temperature of air flowing into the aerosol generating article 10 may increase. That is, in the heater assembly 300 according to another embodiment, external air introducing into the aerosol generating article 10 may be preheated in the process of moving along the airflow passage 340 without a separate power supply voltage, and accordingly, the power required for generating an aerosol may be reduced.

According to one embodiment, the resonance unit 320 may further include a structure 341 (or a “cap”) for supporting the aerosol generating article 10 accommodated in the accommodation space 320h.

The structure 341 is arranged inside the accommodation space 320h and may support at least one region of the aerosol generating article 10 accommodated in the accommodation space 320h. For example, the structure 341 may be formed in a hollow cylindrical shape with one end closed and the other end open, and may surround one region of the aerosol generating article 10, and accordingly, a position of the aerosol generating article 10 may be fixed in the accommodation space 320h.

Also, the structure 341 may prevent movement or spread of the aerosol generating article 10 toward the first internal conductor 323 and/or the second internal conductor 325, and accordingly, droplets are prevented from being generated inside the resonance unit 320.

When an aerosol generated from the aerosol generating article 10 reaches the first internal conductor 323 and/or the second internal conductor 325, a part of the aerosol may be liquefied to generate droplets inside the first internal conductor 323 and/or the second internal conductor 325. The droplets generated in the first internal conductor 323 and/or the second internal conductor 325 may reduce heating efficiency of the resonance unit 320, and the heater assembly 300 according to another embodiment may prevent a reduction of the heating efficiency due to the droplets by preventing an aerosol from moving or spreading toward the first internal conductor 323 and/or the second internal conductor 325 through the structure 341.

In this case, the structure 341 may include a material (for example, a polytetrafluoroethylene material) with excellent heat resistance and/or chemical resistance to prevent damage caused by an aerosol or droplets generated inside the accommodation space 320h.

According to one embodiment, the structure 341 may include an air inlet hole 341h penetrating the structure 341 and connected to the airflow passage 340. The air inlet hole 341h may be formed in a closed end of the structure 341, and external air reaching the structure 341 along the airflow passage 340 may be introduced into the aerosol generating article 10 supported by the structure 341 through the air inlet hole 341h. That is, by having the air inlet hole 341h, the structure 341 may support the aerosol generating article 10 and does not hinder a flow of external air toward the aerosol generating article 10.

That is, the heater assembly 300 according to another embodiment may not only increase insulation efficiency of the resonance unit 320 through the airflow passage 340 and the structure 341 described above but also increase dielectric heating efficiency by preventing droplets from being generated in the first internal conductor 323 and/or the second internal conductor 325 that operate as a resonator.

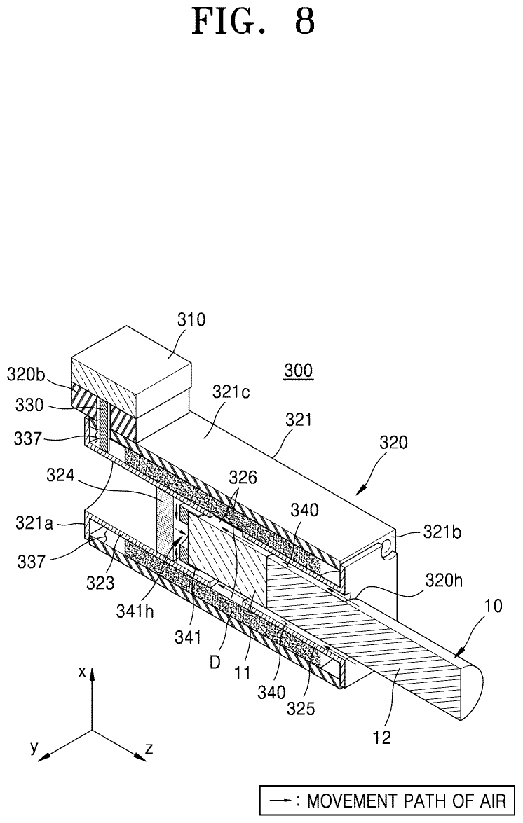

FIG. 8 is a cross-sectional view of a heater assembly 800 according to another embodiment.

Referring to FIG. 8, the heater assembly 300 according to another embodiment may include an oscillator 310, a resonance unit 320, a coupler 330, an airflow passage 340, a structure 341, and a dielectric D. The heater assembly 300 according to another embodiment may be an assembly in which only an arrangement position of the dielectric D is changed in the heater assembly 300 of FIG. 7, and accordingly, redundant descriptions thereof are omitted below.

Due to a structure of the resonance unit 320 and/or a connection relationship between the resonance unit 320 and the coupler 330, a resonance frequency of a first region operating as the first resonator may be different from a resonance frequency of a second region operating as the second resonator. For example, a length of the first inner conductor 323 forming the first region may be different from a length of the second inner conductor 325 forming the second region, or the first inner conductor 323 forming the first region may be directly connected to the coupler 330, while the second inner conductor 325 forming the second region may not be connected to the coupler 330, and accordingly, a resonance frequency of the first region may be higher than a resonance frequency of the second region.

When the resonance frequency of the first region is different from the resonance frequency of the second region, intensities of electric fields generated in the first region and the second region by the first resonator according to the resonance of microwaves may be different from each other, and accordingly, heating efficiency of the aerosol generating article 10 may be decreased.

In the heater assembly 300 according to another embodiment, the dielectric D is separated from the second surface 321b of the outer conductor 321 by a preset distance in the dielectric accommodation space 337, and accordingly, a difference between a resonance frequency of the first region and a resonance frequency of the second region may be compensated. For example, one end (for example, one end in the z direction) of the dielectric D facing the second surface 321b may be separated by a preset distance from the second surface 321b. In this case, the “preset distance” may indicate a distance between the dielectric D and the second surface 321b for matching resonance frequencies of the first region and the second region.

As the dielectric D is separated from the second surface 321b by a preset distance, an area of the dielectric D surrounding the first internal conductor 323 is different from an area of the dielectric D surrounding the second internal conductor 325, and accordingly, the resonance frequencies of the first region and the second region may be adjusted, and as a result, the resonance frequency of the first region may match the resonance frequency of the second region.

The heater assembly 300 according to another embodiment enables the resonance frequency of the first region operating as the first resonator to match the resonance frequency of the second region operating as the second resonator regardless of a shape of the resonance unit 320 or a connection relationship between the resonance unit 320 and the coupler 330 through an arrangement structure of the dielectric D described above, and as a result, the entire heating efficiency (or “dielectric heating efficiency”) of the heater assembly 300 may be increased.

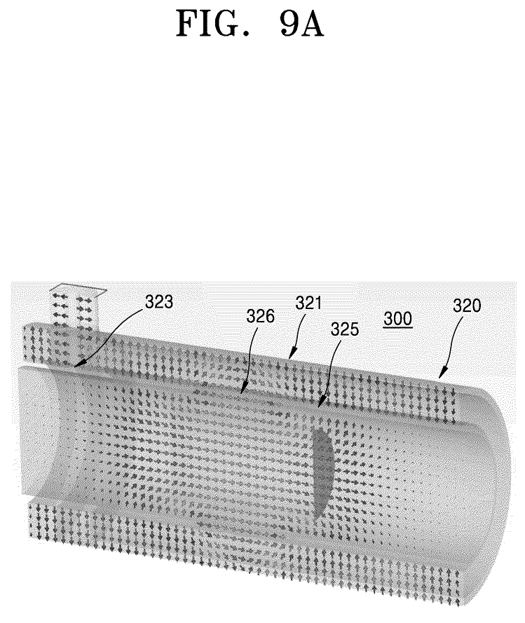

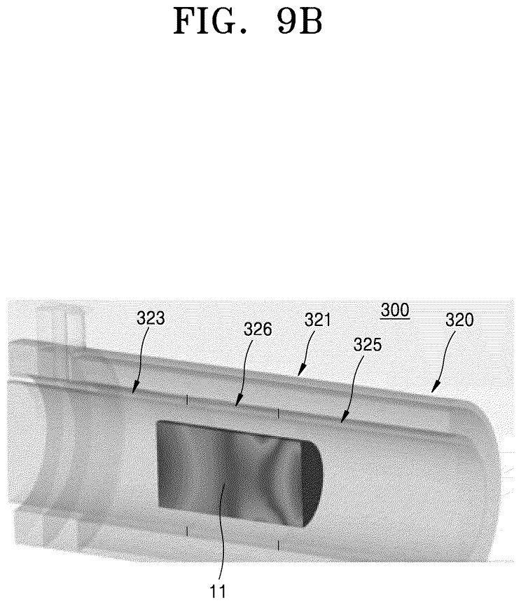

FIG. 9A is a view illustrating an electric field distribution inside a heater assembly, and FIG. 9B is a view illustrating a heating density distribution of an aerosol generating article heated by the heater assembly. FIGS. 9A and 9B respectively illustrate an electric field distribution inside the heater assembly 300 of FIGS. 6 to 8 and a heating density distribution of the tobacco rod 11 of the aerosol generating article 10 according thereto. In this case, the “electric field distribution” indicates intensity of a voltage (V/m) per unit length of the resonance unit 320, and the “heating density” indicates temperature energy (W/m³) per unit volume in each area of the tobacco rod 11 when the aerosol generating article 10 is heated.

Referring to FIG. 9A, an electric field may be generated by resonance of microwaves in the first region formed between the outer conductor 321 and the first inner conductor 323 and in the second region formed between the outer conductor 321 and the second inner conductor 325. At least a part of the electric field generated in the first region and the second region may be propagated to an inner space of the first inner conductor 323 and/or an inner space of the second inner conductor 325 through the gap 326 between the first inner conductor 323 and the second inner conductor 325.

It can be seen that, as the electric field generated in the first region and the electric field generated in the second region are introduced into the first inner conductor 323 and/or the second inner conductor 325 through the gap 326, the strongest electric field is generated in a peripheral region of the gap 326 in the inner region of the resonance unit 320.

Referring to FIG. 9B, it can be seen that, as the strongest magnetic field is generated in the gap 326 between the first inner conductor 323 and the second inner conductor 325, one region of the tobacco rod 11 placed at a position corresponding to the gap 326 has a higher heating density than the other regions of the tobacco rod 11.

The heater assembly 300 according to embodiments of the present disclosure may increase dielectric heating efficiency by arranging the tobacco rod 11 at a position corresponding to the gap 326 between the first inner conductor 323 and the second inner conductor 325 where the electric field is strongest.

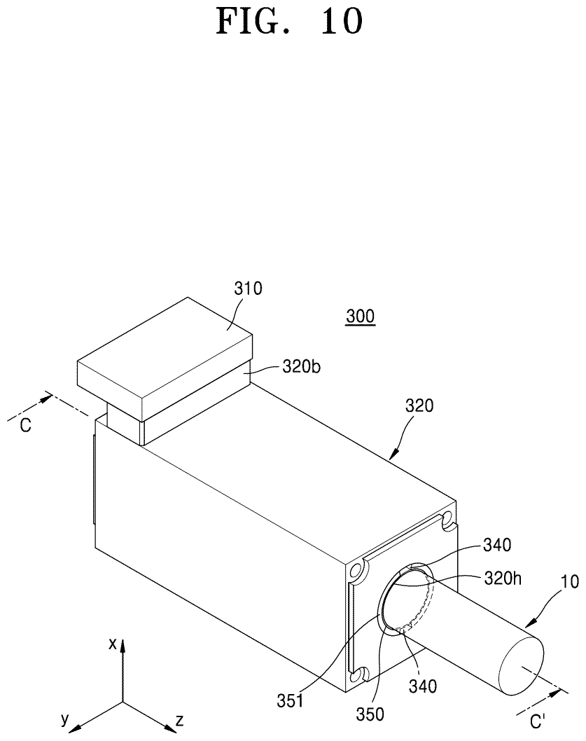

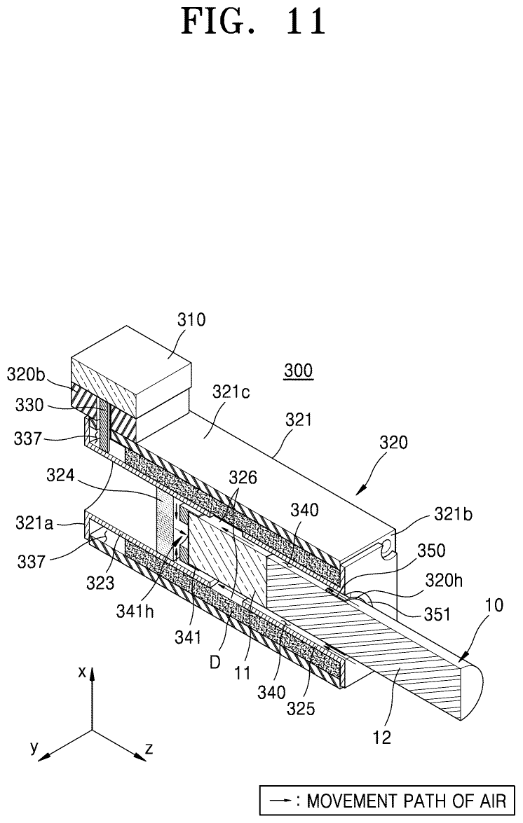

FIG. 10 is a perspective view of a heater assembly 300 according to another embodiment.

Referring to FIG. 10, the heater assembly 300 according to another embodiment may include an oscillator 310, a resonance unit 320, an airflow passage 340, a support member 350, and a fixing member 351. The heater assembly 300 according to another embodiment may be an assembly in which the support member 350 and the fixing member 351 are added to the heater assembly 300 of FIGS. 6 to 8, and accordingly, redundant descriptions thereof are omitted below.

The support member 350 may be arranged in the accommodation space 320h to surround at least one region of an aerosol generating article 10 accommodated in an accommodation space 320h, thereby supporting the aerosol generating article 10.

When the aerosol generating article 10 is accommodated in the accommodation space 320h, the support member 350 may fix a position of the aerosol generating article 10 such that a central axis of the aerosol generating article 10 is aligned with a central axis of the accommodation space 320h. For example, when a change occurs in an arrangement position of the aerosol generating article 10 during the use of the heater assembly 300, the dielectric heating efficiency may be decreased.

The heater assembly 300 according to another embodiment may prevent the heating efficiency from being decreased due to a change in a position of the aerosol generating article 10 by fixing the position of the aerosol generating article 10 in the accommodation space 320h through the support member 350.

The fixing member 351 may connect an inner surface of the accommodation space 320h to the support member 350 to fix the support member 350. For example, the fixing member 351 may extend in a direction from an inner side of the accommodation space 320h toward the center of the accommodation space 320h to be connected to the support member 350, and a position of the support member 350 may be fixed in the accommodation space 320h by the fixing member 351.

Although only an embodiment in which the resonance unit 320, the support member 350, and the fixing member 351 are formed as separate configurations is illustrated in FIG. 10, the resonance unit 320, the support member 350, and the fixing member 351 may also be formed integrally depending on embodiments.

Also, in the heater assembly 300 according to another embodiment, the airflow passage 340 may be formed in a free space between the accommodation space 320h, the support member 350, and the fixing member 351, and external air may be introduced into the resonance unit 320 through the airflow passage 340. The external air introduced into the resonance unit 320 may be mixed with the vapor generated as the aerosol generating article 10 is heated by the resonance unit 320 by using a dielectric heating method to generate an aerosol, and the generated aerosol may pass through the aerosol generating article 10 to be discharged outside the heater assembly 300.

Hereinafter, an arrangement structure of the support member 350 for supporting the aerosol generating article 10 is specifically described with reference to FIG. 11.

FIG. 11 is a cross-sectional view of the heater assembly 300 of FIG. 10. FIG. 11 illustrates a cross-section of the heater assembly 300 of FIG. 10 taken along line C-C′, and redundant descriptions thereof are omitted below.

Referring to FIG. 11, the heater assembly 300 according to another embodiment may include the oscillator 310, the resonance unit 320, a coupler 330, the airflow passage 340, the support member 350, and the fixing member 351.

The support member 350 is inside the accommodation space 320h by the fixing member 351 and may fix a position of the aerosol generating article 10 accommodated in the accommodation space 320h. For example, the support member 350 is formed in a hollow cylindrical shape and surrounds at least a part of an outer circumferential surface of the aerosol generating article 10 accommodated in the accommodation space 320h, thereby fixing a position of the aerosol generating article 10 in the accommodation space 320h.

In order to increase dielectric heating efficiency, the tobacco rod 11 of the aerosol generating article 10 has to be arranged at a position corresponding to the gap 326 between the first inner conductor 323 and the second inner conductor 325 where the strongest electric field is generated.

When a position of the aerosol generating article 10 is not fixed in the accommodation space 320h, the aerosol generating article 10 may move during the use of the heater assembly 300, causing a position of the tobacco rod 11 to be deviated from the gap 326 where the strongest electric field is generated, and in this case, the dielectric heating efficiency of the heater assembly 300 may be decreased.

In addition, the heater assembly 300 according to another embodiment may prevent heating efficiency from being decreased due to movement of the aerosol generating article 10 during the use of the heater assembly 300 by fixing a position of the aerosol generating article 10 within the accommodation space 320h through the support member 350 such that the tobacco rod 11 is placed at a position corresponding to the gap 326.

The support member 350 not only may fix the position of the aerosol generating article 10, but also may function as an insulator that prevents the heat generated from the aerosol generating article 10 from being transferred to the first internal conductor 323 and/or the second internal conductor 325 that operate as resonators. For example, because the support member 350 surrounds the outer circumferential surface of the aerosol generating article 10, it is possible to prevent the heat generated from the aerosol generating article 10 from being transferred to the first internal conductor 323 and/or the second internal conductor 325 of the resonance unit 320. In this case, the support member 350 may include a material (for example, a polytetrafluoroethylene material) with excellent heat resistance and/or chemical resistance but is not limited thereto.

That is, the heater assembly 300 according to another embodiment may prevent heating efficiency from being decreased due to movement of the aerosol generating article 10 by fixing a position of the aerosol generating article 10 through the support member 350 and the fixing member 351 and prevent the resonance unit 320 from being overheated during the use of the heater assembly 300 by preventing the heat generated from the aerosol generating article 10 from being transferred to the resonance unit 320.

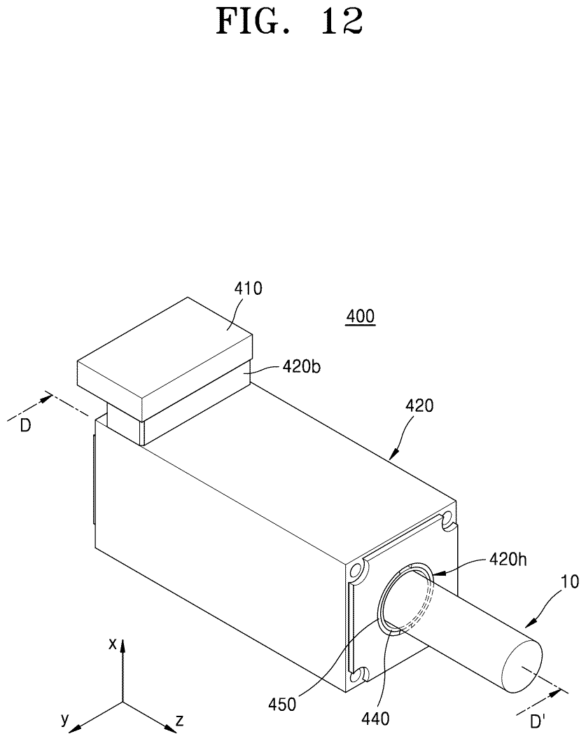

FIG. 12 is a perspective view of a heater assembly 400 according to another embodiment.

Referring to FIG. 12, the heater assembly 400 according to another embodiment may include an oscillator 410 (for example, the oscillator 210 of FIG. 4), a resonance unit 420 (for example, the resonance unit 220 of FIG. 4), and a structure 440. The heater assembly 400 according to another embodiment may be an assembly in which the structure 440 is added to the heater assembly 200 of FIG. 4, and accordingly, redundant descriptions thereof are omitted below.

The oscillator 410 may generate microwaves in a designated frequency band as power is supplied. The microwaves generated by the oscillator 410 may be transmitted to the resonance unit 420 through the coupler (for example, the coupler 230 of FIG. 5) connecting the oscillator 410 to the resonance unit 420.

The resonance unit 420 may include an accommodation space 420h (for example, the accommodation space 220h of FIG. 4) in which at least a part of an aerosol generating article 10 may be inserted into the resonance unit 420, and may heat the inserted aerosol generating article 10 by resonating the microwaves generated by the oscillator 410 by using a dielectric heating method.

For example, microwaves may be resonated by the resonance unit 420, and accordingly, an electric field may be generated inside the resonance unit 420. Electric charges of a dielectric (for example, glycerin) included in an aerosol generating article 10 inserted inside the resonance unit 420 may vibrate or rotate by an electric field, and heat may be generated by the dielectric due to frictional heat generated when the electric charges vibrate or rotate, and accordingly, the aerosol generating article 10 may be heated. As the vapor generated from the aerosol generating article 10 is mixed with air, an aerosol may be generated inside the resonance unit 420, and the generated aerosol may pass through the aerosol generating article 10 to be discharged to the outside of the resonance unit 420.

The structure 440 may be arranged in the accommodation space 420h to surround an outer circumferential surface inserted into the accommodation space 420h, and accordingly, the aerosol generated from the aerosol generating article 10 may be prevented from spreading into the resonance unit 420.

When the aerosol is spread into the resonance unit 420, a part of an aerosol may be liquefied to accumulate droplets inside the resonance unit 420, and the droplets accumulated inside the resonance unit 420 may change characteristics (for example, a resonant frequency) of the resonance unit 420, and accordingly, heating efficiency of the resonance unit 420 may be decreased. The heater assembly 400 according to another embodiment may prevent droplets from being accumulated inside the resonance unit 420 by preventing an aerosol from spreading into the resonance unit 420 through the structure 440.

According to one embodiment, the heater assembly 400 may further include a fixing member 450 that fixes the structure 440 to the inside of the accommodation space 420h.

The fixing member 450 has one end coupled to an inner surface of the accommodation space 420h and the other end coupled to an outer circumferential surface of the structure 440, and accordingly, the structure 440 may be fixed to the inside of the accommodation space 420h in a state of being separated by a preset distance from the inner surface of the resonance unit 420.

The heater assembly 400 according to another embodiment may reduce the amount of heat transferred from the aerosol generating article 10 to the inside of the resonance unit 420 by separating, by a preset distance, the structure 440 surrounding the aerosol generating article 10 from an inner surface of the resonance unit 420 through the fixing member 450. As a result, the heater assembly 400 according to another embodiment may prevent the resonance unit 420 from being overheated by heat generated from the aerosol generating article 10.

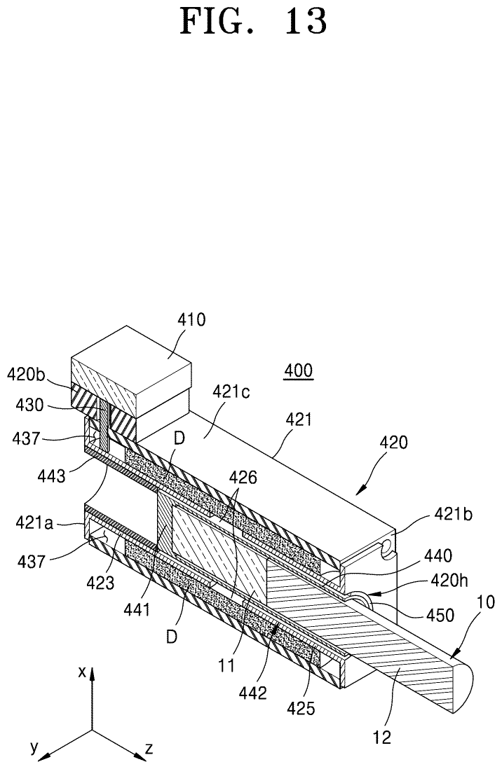

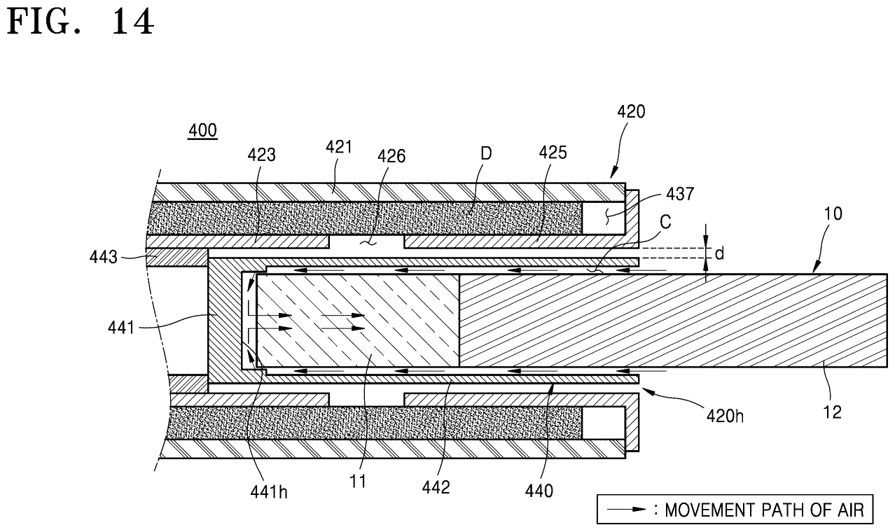

Hereinafter, the structure 440 is specifically described with reference to FIGS. 13 and 14.

FIG. 13 is a cross-sectional view of the heater assembly 400 of FIG. 12. FIG. 13 illustrates a cross-section of the heater assembly 400 of FIG. 12 taken along line D-D′.

Referring to FIG. 13, the heater assembly 400 according to another embodiment may include the oscillator 410, the resonance unit 420, a coupler 430, the structure 440, and the fixing member 450. Components of the heater assembly 400 according to another embodiment may be identical or similar to at least one of components of the heater assembly 400 of FIG. 12, and accordingly, redundant descriptions thereof are omitted below.

The oscillator 410 may generate microwaves in a designated frequency band as an AC voltage is applied, and the microwaves generated by the oscillator 410 may be transmitted to the resonance unit 420 through the coupler 430.

The resonance unit 420 may surround at least a part of an aerosol generating article 10 inserted into the aerosol generating device (for example, the aerosol generating device 100 of FIG. 1), and may heat the aerosol generating article 10 by resonating microwaves generated by the oscillator 410. For example, dielectrics included in the aerosol generating article 10 may generate heat by an electric field generated inside the resonance unit 420 according to resonance of microwaves, and the aerosol generating article 10 may be heated by the heat generated in the dielectric.

According to one embodiment, the resonance unit 420 may include an outer conductor 421, a first inner conductor 423, and a second inner conductor 425.

The outer conductor 421 may form the entire appearance of the resonance unit 420 and may be formed in a hollow shape with an empty inner space such that components of the resonance unit 420 may be arranged inside the outer conductor 421. The outer conductor 421 may have an accommodation space 420h in which at least one region of an aerosol generating article 10 may be inserted into the outer conductor 421. The accommodation space 420h may indicate a space which is formed by the first inner conductor 423 and/or the second inner conductor 425 arranged inside the outer conductor 421 and may accommodate the aerosol generating article 10 inserted into the outer conductor 421.

According to one embodiment, the outer conductor 421 may include a first surface 421a, a second surface 421b facing the first surface 421a, and a side surface 421c surrounding a space between the first surface 421a and the second surface 421b. At least some (for example, the first inner conductor 423 and the second inner conductor 425) of components of the resonance unit 420 may be arranged in an inner space of the resonance unit 420 which is formed by the first surface 421a, the second surface 421b, and the side surface 421c.

The first inner conductor 423 may be formed in a hollow cylindrical shape extending from the first surface 421a of the outer conductor 421 along a direction facing an inner space of the outer conductor 421 or along a longitudinal direction of the outer conductor 421.

According to one embodiment, one region of the first inner conductor 423 may be in contact with the coupler 430 connected to the oscillator 410, and the microwaves generated by the oscillator 410 may be transmitted to the first inner conductor 423 through the coupler 430. For example, the coupler 430 may pass through the outer conductor 421 and has one end in contact with the oscillator 410 and the other end in contact with one region of the first inner conductor 423, and the microwaves generated by the oscillator 410 may be transmitted to the first inner conductor 423 through the coupler 430.

In this case, the coupler 430 may pass through the outer conductor 421 without being in contact with the outer conductor 421 to transfer the microwave, but when the microwaves generated by the oscillator 410 may be transmitted to the first inner conductor 423, the arrangement structure of the coupler 430 is not limited thereto.

A first region formed between the outer conductor 421 and the first inner conductor 423 may operate as a “first resonator” that generates an electric field according to resonance of microwaves. The first region may refer to a space formed by the first surface 421a, the side surface 421c of the outer conductor 421, and the first inner conductor 423, and an electric field may be generated in the first region by resonance of microwaves transmitted through the coupler 430.

The second inner conductor 425 may be formed in a hollow cylindrical shape extending from the second surface 421b of the outer conductor 421 along a direction facing an inner space of the outer conductor 421 or along a longitudinal direction of the outer conductor 421. T The second inner conductor 425 may be separated from the first inner conductor 423 by a preset distance in an inner space of the outer conductor 421, and a gap 426 may be formed between the first inner conductor 423 and the second inner conductor 425.

A second region formed between the outer conductor 421 and the second inner conductor 425 may operate as a “second resonator” that generates an electric field according to resonance of microwaves. The second inner conductor 425 may be coupled (capacitively coupled) with the first inner conductor 423, and when an electric field is generated in the first region by a coupling relationship described above, an induced electric field may also be generated in the second region.

For example, when a microwave generated by the oscillator 410 is transmitted to the first inner conductor 423, an electric field may be generated in the first region by resonance, and an induced electric field may be generated in the second region formed by the second inner conductor 425 coupled with the outer conductor 421 and the first inner conductor 423.

According to one embodiment, the first region and the second region of the resonance unit 420 may operate as a resonator having a length of ¼ wavelength (λ) of a microwave.

In one example, one end (for example, one end in the −z direction) of the first region may be formed as a closed end (a short end) as a cross-section of the first region is closed by the first surface 421a of the outer conductor 421, and the other end (for example, an end in the z direction) of the first region may be formed as an open end as a cross-section is opened because the first surface 421a is not arranged. In another example, one end (for example, one end in the −z direction) of the second region may be formed as an open end as a cross-section is opened, and the other end (for example, one end in the z direction) of the second region may be formed as a closed end as a cross-section of the second region is closed by the second surface 321b of the outer conductor 421.

That is, the entire shape of each of the first region and the second region, which includes the closed end and the open end, may be formed in a “ [symbol] ” shape when viewed on an xz plane, and the first region and the second region may operate as a resonator having a ¼ wavelength length of a microwave through the above-described structure.

According to one embodiment, the first inner conductor 423 and the second inner conductor 425 may be formed to have the same length based on a z axis, such that the first region and the second region may be arranged symmetrically to each other, but the present disclosure is not limited thereto.

The aerosol generating article 10 inserted into an inner space of the outer conductor 421 through the accommodation space 420h may be surrounded by the first inner conductor 423 and the second inner conductor 425 and heated by a dielectric heating method.

At least a part of an electric field generated by resonance of microwaves in the first region and/or the second region may be propagated into the first inner conductor 423 and/or the second inner conductor 425 through the gap 426 between the first inner conductor 423 and the second inner conductor 425, and the aerosol generating article 10 surrounded by the first inner conductor 423 and the second inner conductor 425 may be heated by the electric field propagated into the first inner conductor 423 and/or the second inner conductor 425. For example, a dielectric included in the aerosol generating article 10 may be heated by the electric field propagated through the gap 426, and the aerosol generating article 10 may be heated by the heat generated from the dielectric. In this case, the vapor generated as the aerosol generating article 10 is heated may be mixed with external air flowing into the resonance unit 420 to generate an aerosol.

The heater assembly 400 according to another embodiment may prevent an electric field transferred into the first inner conductor 423 and/or the second inner conductor 425 from leaking to the outside of the heater assembly 400 or the resonance unit 420 when diameters of the first inner conductor 423 and the second inner conductor 425 are less than a designated value.

In the present disclosure, the “designated value” may indicate a diameter value at which an electric field begins to leak to the outside of the first inner conductor 423 and/or the second inner conductor 425. For example, when a diameter of the first inner conductor 423 and/or a diameter of the second inner conductor 425 is greater than a designated value, a part of the electric field introduced into the first inner conductor 423 and/or the second inner conductor 425 may leak to the outside of the resonance unit 420.

In addition, the heater assembly 400 according to another embodiment may prevent an electric field from being transferred to the outside of the resonance unit 420 through a structure in which diameters of the first inner conductor 423 and the second inner conductor 425 are less than a designated value, and as a result, the electric field may be prevented from leaking to the outside of the heater assembly 400 or the resonance unit 420 without a separate shielding member.

According to one embodiment, when the aerosol generating article 10 is inserted into the resonance unit 420 through the accommodation space 420h, a tobacco rod 11 of the aerosol generating article 10 may be arranged at a position corresponding to the gap 426 between the first inner conductor 423 and the second inner conductor 425.

As an electric field generated in the first region and an electric field generated in the second region are introduced into the first inner conductor 423 and/or the second inner conductor 425 through the gap 426, the strongest electric field may be generated in a peripheral region of the gap 426 among the inner regions of the resonance unit 420. In the heater assembly 400 according to another embodiment, by arranging the tobacco rod 11 including a dielectric for generating heat by using an electric field at a position corresponding to the gap 426 where the electric field is strongest, the heating efficiency of the heater assembly 400 may be increased.

According to one embodiment, the resonance unit 420 may further include a dielectric accommodation space 437 and a dielectric D accommodated in the dielectric accommodation space 427 to adjust a dielectric constant of the resonance unit 420. The dielectric accommodation space 437 may be formed in a free space between the outer conductor 421 and the first inner conductor 423 and the second inner conductor 425, and the dielectric D may be accommodated in the dielectric accommodation space 437. For example, the dielectric D may be at least one of quartz with low microwave absorption, tetrafluoroethylene, and aluminum oxide, or a combination thereof, but the type of the dielectric D is not limited thereto.

In the heater assembly 400 according to another embodiment, by arranging the dielectric D inside the dielectric accommodation space 437, the entire size of the resonance unit 420 may be reduced, and an electric field identical to the electrical field generated by the resonance unit 420 that does not include a dielectric may be generated. That is, in the heater assembly 400 according to another embodiment, a size of the resonance unit 420 may be reduced by the dielectric D arranged inside the dielectric accommodation space 437, and accordingly, an accommodation space of the resonance unit 420 in the aerosol generating device may be reduced, and as a result, the aerosol generating device (for example, the aerosol generating device 100 of FIG. 1) may be reduced in size.

The structure 440 may be arranged in the first inner conductor 423 and the second inner conductor 425 to surround an outer circumferential surface of the aerosol generating article 10 inserted into the accommodation space 420h, and accordingly, an aerosol generated from the aerosol generating article 10 may be prevented from spreading in a direction toward the first inner conductor 423 and/or the second inner conductor 425.

According to one embodiment, the structure 440 may include a first portion 441 that accommodates one end of the aerosol generating article 10 inserted into the accommodation space 420h, and a second portion 442 that extends from the first portion 441 and surrounds an outer circumferential surface of the aerosol generating article 10 inserted into the accommodation space 420h.

The first portion 441 may be arranged inside the first inner conductor 423 to close a part of a cross-section of the first inner conductor 423, and at least one region (for example, one region facing the z direction) of the first portion 441 may accommodate one end (for example, one end in the −z direction) of the aerosol generating article 10 inserted into the accommodation space 420h. For example, the first portion 441 may be formed in a cylindrical shape that closes a part of the cross-section of the first inner conductor 423, but a shape of the first portion 441 is not limited thereto.

As the first part 441 accommodates one end of the aerosol generating article 10 inserted into the accommodation space 420h while closing the cross-section of the first inner conductor 423, the first portion 441 may prevent an aerosol discharged from one end of the aerosol generating article 10 from spreading toward the first inner conductor 423 and/or the second inner conductor 425.

The second portion 442 may be formed in a hollow cylindrical shape extending in a longitudinal direction of the accommodation space 420h from the first inner conductor 423 and may surround an outer circumferential surface of the aerosol generating article 10 inserted into the accommodation space 420h. For example, the second portion 442 may extend from the first portion 441 to an entrance of the accommodation space 420h into which the aerosol generating article 10 is inserted, and may surround the entire outer circumferential surface of the aerosol generating article 10 inserted into the accommodation space 420h.

As the second portion 442 surrounds the outer circumferential surface of the aerosol generating article 20, the second portion 442 may prevent an aerosol discharged from the outer circumferential surface of the aerosol generating article 10 from spreading toward the first inner conductor 423 and/or the second inner conductor 425.

When the aerosol is spread into the first internal conductor 423 and/or the second internal conductor 425, a part of the aerosol may be liquefied, and droplets accumulate inside the first internal conductor 423 and/or the second internal conductor 425. When droplets accumulate inside the first internal conductor 423 and/or the second internal conductor 425, characteristics (for example, resonance frequencies) of a first region operating as a first resonator or a second region operating as a second resonator may be changed by the droplets, and accordingly, the entire heating efficiency of the resonance unit 420 may be decreased.

The heater assembly 400 according to another embodiment may prevent an aerosol from spreading in a direction toward the first internal conductor 423 and/or the second internal conductor 425 through the structure 440 including the first portion 441 and the second portion 442, and accordingly, it is possible to prevent heating efficiency from being decreased by droplets.

In this case, the first portion 441 and/or the second portion 442 of the structure 440 may include a material with excellent heat resistance and/or chemical resistance to prevent from being damaged by an aerosol or droplets. For example, the first portion 441 and the second portion 442 may include a polytetrafluoroethylene material but are not limited thereto.

According to one embodiment, the resonance unit 420 may further include a closing portion 443 which is on an inner surface of the first inner conductor 423 and closes a part of a cross-section of the first inner conductor 423. For example, the closing portion 443 may be arranged on the inner surface of the first inner conductor 423 to close a free space between the first inner conductor 423 and the structure 440, and the cross-section of the first inner conductor 423 may be completely closed by the closing portion 443 and the structure 440.

The closing portion 443 and the structure 440 close the cross-section of the first inner conductor 423 to block movement of an aerosol, which is generated from the aerosol generating article 10, in the −z direction. When the aerosol generated from the aerosol generating article 10 or the droplets generated as the aerosol is liquefied flows in the −z direction to introduce into another component of the aerosol generating device (for example, the aerosol generating device 100 of FIG. 1), components of the aerosol generating device may be malfunctioned or damaged.

In addition, the heater assembly 300 according to another embodiment may prevent malfunction or damage of components of the aerosol generating device due to an aerosol or droplets by limiting a flow direction of the aerosol through the arrangement structure of the closing unit 324 and the structure 400.

Hereinafter, a process in which external air is introduced into the resonance unit 420 is described in detail with reference to FIG. 14.

FIG. 14 is a view illustrating an air movement path of the heater assembly 400 of FIG. 12. FIG. 14 is a view illustrating the heater assembly 400 of FIG. 12, some components of which are omitted for the sake of convenience of description, and components of the heater assembly 400 are not limited thereto. In addition, in FIG. 14, arrows indicate movement paths of air (or “external air”).

Referring to FIG. 14, a heater assembly 400 according to another embodiment may include a resonance unit 420, a dielectric accommodation space 437, a dielectric D, a coupler 430, a structure 440, and a closing portion 443. Components of the heater assembly 400 according to another embodiment may be identical or similar to at least one of the components of the heater assembly 400 of FIG. 13, and redundant descriptions thereof are omitted below.

An airflow passage C, through which external air may be introduced, may be formed between an aerosol generating article 10 inserted into the resonance unit 420 through an accommodation space 420h and the structure 440. The airflow passage C may indicate a free space formed between an aerosol generating article 10 and a second portion 442 of the structure 440 when the aerosol generating article 10 is inserted into the resonance unit 420.

The airflow passage C may connect the outside of the resonance unit 420 to the aerosol generating article 10 surrounded by the structure 440, and external air may be introduced into the structure 440 through the airflow passage C and then reach the aerosol generating article 10. For example, the external air may move along the airflow passage C to reach a groove 441h of the structure 440 connected to the airflow path C, and then, reach the inside of the aerosol generating article 10 through one end of the aerosol generating article 10 accommodated in the groove 441h.

The external air reached the inside of the aerosol generating article 10 may be mixed with the vapor generated as the aerosol generating article 10 is heated by an electric field generated in a first region where the aerosol generating article 10 operates as a first resonator and in a second region where the aerosol generating article 10 operates as a second resonator to generate an aerosol, and the generated aerosol may pass through the aerosol generating article 10 to be discharged to the outside of the heater assembly 400.

According to one embodiment, the structure 440 may include the groove (or ‘recess’) 441h that accommodates at least one region of the aerosol generating article 10 to fix a position of the aerosol generating article 10 inside the structure 440h. For example, the groove 441h may be formed in a first portion 441 of the structure 440 to accommodate one end (for example, one end in the −z direction of FIG. 13) of the aerosol generating article 10 and a peripheral region thereof.

Although not illustrated in FIG. 14, the first portion 441 may further include a support structure for supporting at least one region of the aerosol generating article 10 accommodated in the groove 441h, and as the aerosol generating article 10 is supported in the groove 441h by the support structure, a position of the aerosol generating article 10 accommodated in the groove 441h may be fixed.

Through the structure described above, even when the aerosol generating article 10 is separated from the second portion 442 of the structure 440 to form the airflow passage C, the position of the aerosol generating article 10 may be stably fixed in the structure 440h.

According to one embodiment, the structure 440 may be arranged in the accommodation space 420h to be separated from inner surfaces of the first inner conductor 423 and the second inner conductor 425 by a preset distance d. As the structure 440 is separated from the inner surfaces of the first inner conductor 423 and the second inner conductor 425 by the preset distance d, the heat generated from the aerosol generating article 10 may be prevented from being transferred to the first inner conductor 423 and the second inner conductor 425. For example, as a part of the external air is introduced into a space between the structure 440 and the first inner conductor 423 and the second inner conductor 425, the heat transferred from the aerosol generating article 10 to the first inner conductor 423 and the second inner conductor 425 by the external air may be reduced, and accordingly, the first inner conductor 423 may be insulated from the second inner conductor 425.

When the first inner conductor 423 and the second inner conductor 425 constituting a resonator are overheated by the heat generated from the aerosol generating article 10, the dielectric heating efficiency may be decreased. The heater assembly 400 according to another embodiment may prevent a decrease in heating efficiency due to overheating of a resonance unit 420 through a structure in which the structure 440 is separated from the first internal conductor 423 and the second internal conductor 425 by the preset distance d.

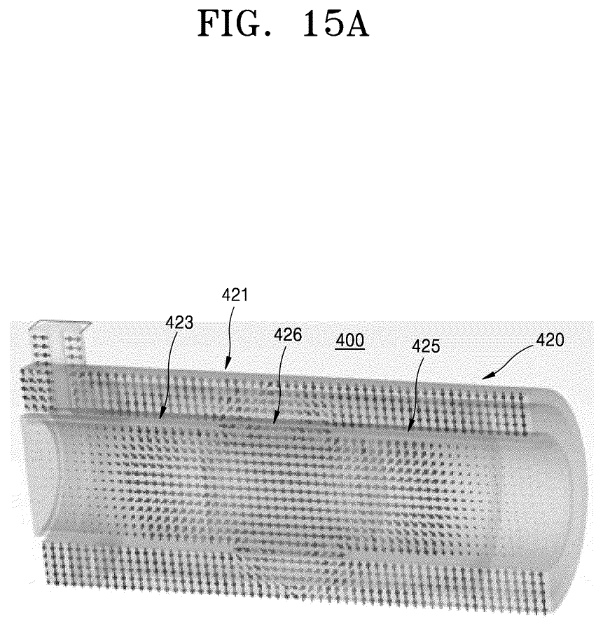

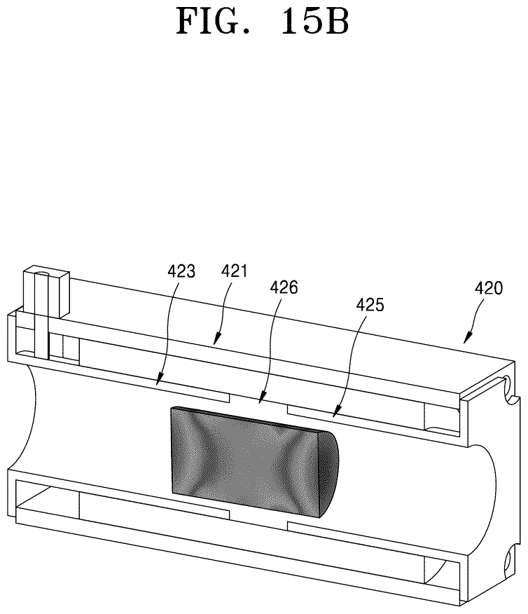

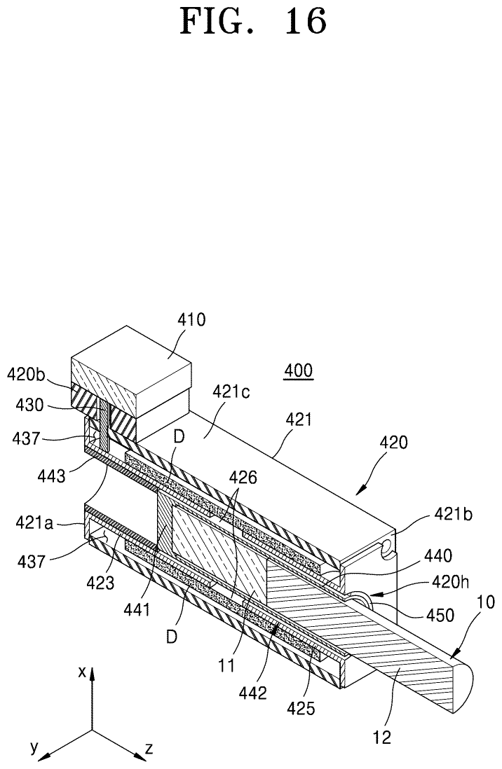

FIG. 15A is a view illustrating an electric field distribution inside a heater assembly, and FIG. 15B is a view illustrating a heating density distribution of an aerosol generating article heated by the heater assembly. FIG. 15A and FIG. 15B illustrate an electric field distribution inside the heater assembly 400 of FIG. 12 to FIG. 14 and a heating density distribution of a tobacco rod 11 of the aerosol generating article 10 according to the electric field distribution.

In this case, the “electric field distribution” represents the intensity of a voltage (V/m) per unit length of the resonance unit 420, and the “heating density” represents temperature energy (W/m³) per unit volume in each region of the tobacco rod 11 when the aerosol generating article 10 is heated.

Referring to FIG. 15A, an electric field may be generated by resonance of microwaves inside a first region formed between the outer conductor 421 and the first inner conductor 423 and a second region formed between the outer conductor 421 and the second inner conductor 425. At least a part of the electric field generated inside the first region and the second region may be spread in an inner space of the first internal conductor 423 and/or an inner space of the second internal conductor 425 through the gap 426 between the first internal conductor 423 and the second internal conductor 425.

It can be seen that, as the electric field generated in the first region and the electric field generated in the second region are introduced into the first internal conductor 423 and/or the second internal conductor 425 through the gap 426, the strongest electric field is generated in a peripheral region of the gap 426 in the inner region of the resonance unit 420.

Referring to FIG. 15B, it can be seen that, as the strongest electric field is generated in the gap 426 between the first inner conductor 423 and the second inner conductor 425, one region of the tobacco rod 11 arranged at a position corresponding to the gap 426 has a higher heating density than other regions of the tobacco rod 11.

The heater assembly 400 according to embodiments of the present disclosure may increase dielectric heating efficiency because the tobacco rod 11 is arranged at a position corresponding to the gap 426 between the first inner conductor 423 and the second inner conductor 425 where the electric field is strongest.

FIG. 16 is a cross-sectional view of a heater assembly according to another embodiment.

Referring to FIG. 16, a heater assembly 400 according to another embodiment may include an oscillator 410, a resonance unit 420, a dielectric accommodation space 437, a coupler 430, a structure 440, and a dielectric D. The heater assembly (400) according to another embodiment may be an assembly in which only an arrangement position of the dielectric D is changed in the heater assembly 400 of FIGS. 13 and 14, and accordingly, redundant descriptions thereof are omitted below.

Due to a structure of the resonance unit 420 and/or a connection relationship between the resonance unit 420 and the coupler 430, a resonance frequency of a first region operating as a first resonator may be different from a resonance frequency of a second region operating as a second resonator. For example, a length of a first inner conductor 423 forming the first region may be different from a length of a second inner conductor 425 forming the second region, or the first inner conductor 423 forming the first region may be directly connected to the coupler 430, while the second inner conductor 425 forming the second region may not be connected to the coupler 430, and accordingly, a resonance frequency of the first region may be higher than a resonance frequency of the second region.

When the resonance frequency of the first region is different from the resonance frequency of the second region, intensities of electric fields generated in the first region and the second region by the first resonator according to the resonance of microwaves may be different from each other, and accordingly, heating efficiency of an aerosol generating article 10 may be decreased.

In the heater assembly 400 according to another embodiment, the dielectric D is separated from a second surface 421b and a side surface 421c of the outer conductor 421 by a preset distance in the dielectric accommodation space 437, and accordingly, a difference between a resonance frequency of the first region and a resonance frequency of the second region may be compensated. For example, one end of the dielectric D facing the z direction may be separated from the second surface 421b by a first distance, and one region facing the side surface 421c may be separated from the side surface 421c by at a second distance. In this case, the “first distance” and the “second distance” may respectively indicate a distance between the dielectric D and the second surface 421b and a distance between the dielectric D and the side surface 421c for matching a resonance frequency of the first region and a resonance frequency of the second region.

As the dielectric D is separated from the second surface 421b of the outer conductor 421, an area of the dielectric D surrounding the first internal conductor 423 is different from an area of the dielectric D surrounding the second internal conductor 425, and accordingly, the resonance frequencies of the first region and the second region may be adjusted, and as a result, the resonance frequency of the first region may match the resonance frequency of the second region The heater assembly 400 according to another embodiment enables a resonance frequency of the first region to match a resonance frequency of the second region regardless of a shape of the resonance unit 420 or a connection relationship between the resonance unit 420 and the coupler 430 through an arrangement structure of the dielectric D described above, and as a result, the entire heating efficiency of the heater assembly 400 may be increased.

Also, as the dielectric D is separated from the side surface 421c of the outer conductor 421, the amount of heat transferred from the inside of the resonance unit 420 to the side surface 421c which is an outer circumferential surface of the resonance unit 420 may be reduced, and as a result, the heater assembly 400 according to another embodiment may prevent a surface temperature of the resonance unit 420 from excessively increasing.

When the surface temperature of the resonance unit 420 excessively increases, components of the aerosol generating device (for example, the aerosol generating device 100 of FIG. 1) may malfunction or be damaged due to the heat generated by the resonance unit 420. The heater assembly 400 according to another embodiment not only increase dielectric heating efficiency through an arrangement structure of the dielectric D described above, but also prevents components of the aerosol generating device from malfunctioning or being damaged by heat by preventing a surface temperature of the resonance unit 420 from increasing.

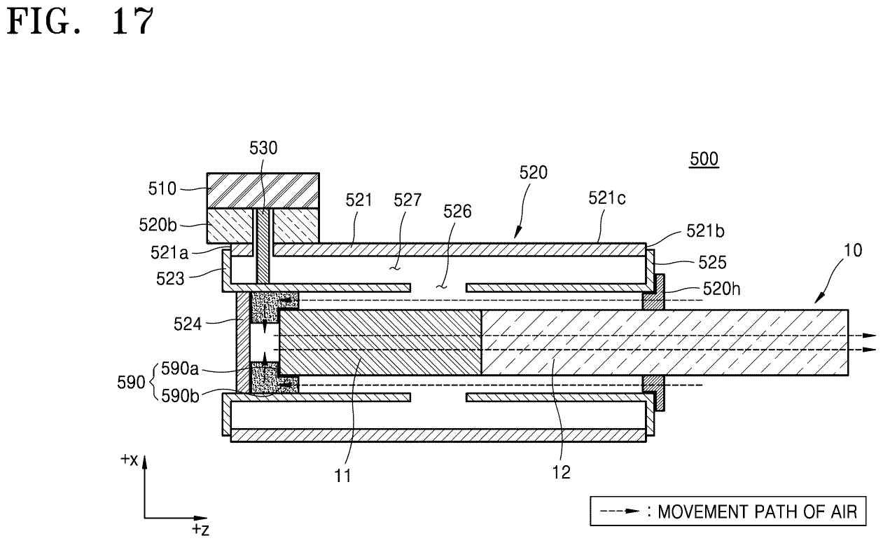

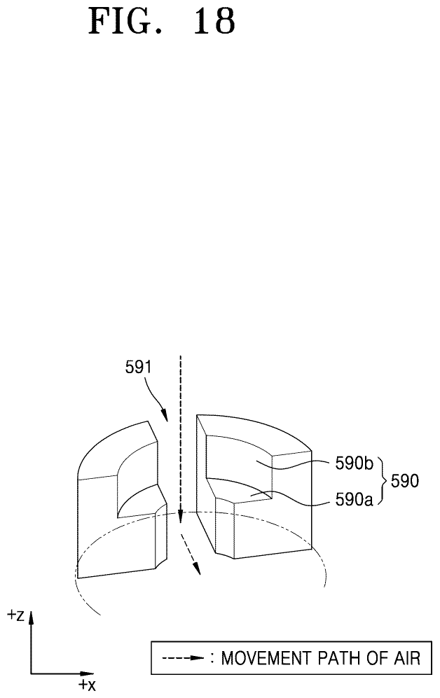

FIG. 17 is an example of a cross-sectional view of the heater assembly of FIG. 4. FIG. 17 illustrates an example of a cross-section of the heater assembly of FIG. 4 which is taken along line A-A′, and arrows in FIG. 17 indicate movement paths of air (or “external air”).

Referring to FIG. 17, a heater assembly 500 according to one embodiment may include an oscillator 510, a resonance unit 520, a coupler 530, and a structure 590.

The oscillator 510 may generate microwaves in a designated frequency band when an AC voltage is applied, and the microwaves generated by the oscillator 510 may be transmitted to the resonance unit 520 through the coupler 530.

The oscillator 510 may be fixed to the resonance unit 520 to prevent separation from the resonance unit 520 during the use of an aerosol generating device (for example, the aerosol generating device 100 of FIG. 1). For example, the oscillator 510 may be fixed on the resonance unit 520 by being supported by a bracket 520b protruding in the x direction in one region of the resonance unit 520. For another example, the oscillator 510 may also be fixed on the resonance unit 520 by being attached to one region of the resonance unit 520 without the bracket 520b.

Although FIG. 17 illustrates only an embodiment in which the oscillator 510 is fixed to one region of the resonance unit 520 facing the x direction, a position of the oscillator 510 is not limited to the illustrated embodiment. In another embodiment, the oscillator 510 may also be fixed to another region of the resonance unit 520 facing the −z direction.

The resonance unit 520 may surround at least one region of an aerosol generating article 10 inserted into the aerosol generating device (for example, the aerosol generating device 100 of FIG. 1) and may heat the aerosol generating article 10 according to the microwaves generated by the oscillator 510. For example, dielectrics included in the aerosol generating article 10 may generate heat by an electric field generated inside the resonance unit 320 by resonance of microwaves, and the aerosol generating article 10 may be heated by the heat generated from the dielectrics.

According to one embodiment, the resonance unit 520 may include an outer conductor 521, a first inner conductor 523, and a second inner conductor 525.

The outer conductor 521 may form the entire appearance of the resonance unit 520 and has an inner portion formed in a hollow shape such that components of the resonance unit 520 may be arranged inside the outer conductor 521. The outer conductor 521 may include an accommodation space in which at least one region of an aerosol generating article 10 may be inserted into the outer conductor 521. The accommodation space may indicate a space formed by the first inner conductor 523 and/or the second inner conductor 525 arranged inside the outer conductor 521 and capable of accommodating an aerosol generating article 10 inserted into the outer conductor 521.

According to one embodiment, the outer conductor 521 may have a first surface 521a, a second surface 521b facing the first surface 321a, and a side surface 521c surrounding a free space between the first surface 521a and the second surface 521b. At least some (for example, the first inner conductor 523 and the second inner conductor 525) of components of the resonance unit 520 may be arranged in an inner space of the resonance unit 520 formed by the first surface 521a, the second surface 521b, and the side surface 521c.

The first inner conductor 523 may be formed in a hollow cylindrical shape extending from the first surface 521a of the outer conductor 521 along a direction facing an inner space of the outer conductor 521 or along a longitudinal direction of the outer conductor 521.

According to one embodiment, one region of the first inner conductor 523 may be in contact with the coupler 530 connected to the oscillator 510, and the microwaves generated by the oscillator 510 may be transmitted to the first inner conductor 523 through the coupler 530. For example, the coupler 530 may pass through the outer conductor 521 and has one end in contact with the oscillator 510 and the other end in contact with one region of the first inner conductor 523, and the microwaves generated by the oscillator 510 may be transmitted to the first inner conductor 523 through the coupler 530.

In this case, the coupler 530 may pass through the outer conductor 521 without being in contact with the outer conductor 521 to transfer the microwave, but when the microwaves generated by the oscillator 510 may be transmitted to the first inner conductor 523, the arrangement structure of the coupler 530 is not limited thereto.

A first region formed between the outer conductor 521 and the first inner conductor 523 may operate as a “first resonator” that generates an electric field according to resonance of microwaves. The first region may refer to a space formed by the first surface 521a, the side surface 521c of the outer conductor 521, and the first inner conductor 523, and an electric field may be generated in the first region by resonance of microwaves transmitted through the coupler 530.

The second inner conductor 525 may be formed in a hollow cylindrical shape extending from the second surface 521b of the outer conductor 521 along a direction facing an inner space of the outer conductor 521 or along a longitudinal direction of the outer conductor 521. The second inner conductor 525 may be separated from the first inner conductor 523 by a preset distance in an inner space of the outer conductor 521, and a gap 526 may be formed between the first inner conductor 523 and the second inner conductor 525.

A second region formed between the outer conductor 521 and the second inner conductor 525 may operate as a “second resonator” that generates an electric field according to resonance of microwaves. The second inner conductor 525 may be coupled (capacitively coupled) with the first inner conductor 523, and when an electric field is generated in the first region by a coupling relationship described above, an induced electric field may also be generated in the second region. In the present disclosure, “capacitive coupling” may indicate a coupling relationship in which energy may be transferred by electrostatic capacity (capacitance) between two conductors.

For example, when a microwave generated by the oscillator 510 is transmitted to the first inner conductor 523, an electric field may be generated in the first region by resonance, and an induced electric field may be generated in the second region formed by the second inner conductor 525 coupled with the outer conductor 521 and the first inner conductor 523.

According to one embodiment, the first region and the second region of the resonance unit 520 may operate as a resonator having a length of ¼ wavelength (λ) of a microwave.

In one example, one end (for example, one end in the −z direction) of the first region may be formed as a closed end (a short end) as a cross-section of the first region is closed by the first surface 521a of the outer conductor 521, and the other end (for example, an end in the z direction) of the first region may be formed as an open end as a cross-section is opened because the first surface 521a is not arranged. In another example, one end (for example, one end in the −z direction) of the second region may be formed as an open end as a cross-section is opened, and the other end (for example, one end in the z direction) of the second region may be formed as a closed end as a cross-section of the second region is closed by the second surface 521b of the outer conductor 521.

That is, the entire shape of each of the first region and the second region, which includes the closed end and the open end, may be formed in a “ [symbol] ” shape when viewed on an xz plane, and through the above-described structure, the first region and the second region may operate as a resonator having a ¼ wavelength length of a microwave.

According to one embodiment, the first inner conductor 523 and the second inner conductor 525 may be formed to have the same length based on a z axis, such that the first region and the second region may be arranged symmetrically to each other, but the present disclosure is not limited thereto.

The aerosol generating article 10 inserted into an inner space of the outer conductor 521 through the accommodation space may be surrounded by the first inner conductor 523 and the second inner conductor 525 and heated by a dielectric heating method.

At least a part of an electric field generated by resonance of microwaves in the first region and/or the second region may be propagated into the first inner conductor 523 and/or the second inner conductor 525 through the gap 526 between the first inner conductor 523 and the second inner conductor 525, and the aerosol generating article 10 surrounded by the first inner conductor 523 and the second inner conductor 525 may be heated by the propagated electric field. For example, a dielectric included in the aerosol generating article 10 may be heated by the electric field propagated through the gap 526, and the aerosol generating article 10 may be heated by the heat generated from the dielectric.

The heater assembly 500 according to another embodiment may prevent an electric field transferred into the first inner conductor 523 and/or the second inner conductor 525 from leaking to the outside of the heater assembly 500 or the resonance unit 520 when diameters of the first inner conductor 523 and the second inner conductor 525 are less than a designated value. In the present disclosure, the “designated value” may indicate a diameter value at which an electric field begins to leak to the outside of the first inner conductor 523 and/or the second inner conductor 525. For example, when a diameter of the first inner conductor 523 and/or a diameter of the second inner conductor 525 is greater than a designated value, a part of the electric field introduced into the first inner conductor 523 and/or the second inner conductor 525 may leak to the outside of the resonance unit 520. In addition, the heater assembly 500 according to another embodiment may prevent an electric field from being transferred to the outside of the resonance unit 520 through a structure in which diameters of the first inner conductor 523 and the second inner conductor 525 are less than a designated value, and as a result, the electric field may be prevented from leaking to the outside of the heater assembly 500 or the resonance unit 520 without a separate shielding member.

According to one embodiment, the resonance unit 520 may further include a dielectric accommodation space 527 and a dielectric D accommodated in the dielectric accommodation space 527 to adjust a dielectric constant of the resonance unit 520.

The dielectric accommodation space 527 may indicate a free space between the outer conductor 521 and the first inner conductor 523 and the second inner conductor 525, and the dielectric D may be accommodated in the dielectric accommodation space 527. For example, the dielectric D may be at least one of quartz with low microwave absorption, tetrafluoroethylene, and aluminum oxide, or a combination thereof, but the type of the dielectric D is not limited thereto.

In the heater assembly 500 according to another embodiment, by arranging the dielectric D inside the dielectric accommodation space 527, the entire size of the resonance unit 520 may be reduced, and an electric field identical to the electrical field generated by the resonance unit 520 that does not include a dielectric may be generated. That is, in the heater assembly 500 according to another embodiment, a size of the resonance unit 520 may be reduced by the dielectric D arranged inside the dielectric accommodation space 527, and accordingly, an accommodation space of the resonance unit 520 in the aerosol generating device may be reduced, and as a result, the aerosol generating device (for example, the aerosol generating device 100 of FIG. 1) may be reduced in size.

According to one embodiment, when the aerosol generating article 10 is inserted into the resonance unit 520 through the accommodation space, a tobacco rod 11 of the aerosol generating article 10 may be arranged at a position corresponding to the gap 526 between the first inner conductor 523 and the second inner conductor 525.

As an electric field generated in the first region and an electric field generated in the second region are introduced into the first inner conductor 523 and/or the second inner conductor 525 through the gap 526, the strongest electric field may be generated in a peripheral region of the gap 526 among the inner regions of the resonance unit 520.

In the heater assembly 500 according to one embodiment, by arranging the tobacco rod 11 including a dielectric for generating heat by using an electric field at a position corresponding to the gap 526 where the electric field is strongest, the heating efficiency (or “dielectric heating efficiency”) of the heater assembly 500 may be increased.

According to one embodiment, the resonance unit 520 may further include a closing unit 524 placed inside the first internal conductor 523 and closing a cross-section of the first internal conductor 523 to limit a flow direction of an aerosol generated from the aerosol generating article 10. For example, the closing unit 524 may close a cross-section of the first internal conductor 523 to block flowing of an aerosol, which is generated from the aerosol generating article 10, in the −z direction.

When the aerosol generated from the aerosol generating article 10 or the droplets generated as the aerosol is liquefied flows in the −z direction to introduce into another component of the aerosol generating device (for example, the aerosol generating device 100 of FIG. 1), components of the aerosol generating device may be malfunctioned or damaged. In addition, the heater assembly 500 according to another embodiment may prevent malfunction or damage of components of the aerosol generating device due to an aerosol or droplets by limiting a flow direction of the aerosol through the closing unit 524.

The structure 590 may be arranged inside the first inner conductor 523 and may support a part of the aerosol generating article 10 inserted into the accommodation space. For example, the structure 590 may include a first portion 590a, and the first portion 590a may support one end of the aerosol generating article 10, and accordingly, the aerosol generating article 10 may be separated from the accommodation space in a direction (for example, the +z-axis direction) toward the outside of the heater assembly 500. In another example, the structure 590 may include a second portion 590b, and as the second portion 590b supports a part of an outer circumferential surface of the aerosol generating article 10, the aerosol generating article 10 may be at a fixed point in the accommodation space. The tobacco rod 11 of the aerosol generating article 10 may be arranged at a position corresponding to the gap 526 between the first inner conductor 523 and the second inner conductor 525 by the structure 590.

The heater assembly 500 according to one embodiment may store a large amount of air inside the accommodation space as the aerosol generating article 10 is supported by the structure 590. Accordingly, the aerosol generating device including the heater assembly 500 according to one embodiment may generate an aerosol having a rich flavor and taste of smoke from the aerosol generating article 10 into which a large amount of air in the accommodation space is introduced. Also, the heat generated from the aerosol generating article 10 by the large amount of air in the accommodation space may be prevented from being transferred to the outside of the resonance unit 520, and accordingly, the heater assembly 500 according to one embodiment may increase the entire insulation performance of the resonance unit 520.

The structure 590 may include an air inlet passage that introduces external air, which is introduced into the accommodation space, into the aerosol generating article 10. For example, the air inlet passage may connect the accommodation space to one end (for example, one end in the −z-axis direction) of the aerosol generating article 10 inserted into the accommodation space. External air introduced into the accommodation space through the air inlet hole of an insertion portion 520h may be introduced into one end of the aerosol generating article 10 through the air inlet passage of the structure 590.

The external air introduced into one end of the aerosol generating article 10 through the air inlet passage may be mixed with the vapor generated as the aerosol generating article 10 is heated to generate an aerosol, and the generated aerosol may be discharged to the outside of the heater assembly 500 by passing through the aerosol generating article 10.

The heater assembly 500 according to one embodiment may have the structure 590 including the air inlet passage to support the aerosol generating article 10 while not impeding a flow of external air toward the aerosol generating article 10.

Hereinafter, a shape and an arrangement structure of the structure 590 of the heater assembly 500 are specifically described with reference to FIG. 18.

FIG. 18 is an enlarged view illustrating a structure of the heater assembly of FIG. 4.

Referring to FIG. 18, a structure 590 (for example, the structure 590 of FIG. 17) of a heater assembly (for example, the heater assembly 500 of FIG. 17) according to one embodiment may include a first portion 590a supporting one region of an aerosol generating article inserted into an accommodation space and a second portion 590b supporting another region different from the one region.

For example, the structure 590 may include the first portion 590a in contact with one end (for example, one end in the −z-axis direction) of the aerosol generating article inserted into the accommodation space. The first portion 590a may be on an inner surface of the accommodation space and may separate the aerosol generating article inserted into the accommodation space from the accommodation space in a longitudinal direction (for example, the +z-axis direction) of the accommodation space.

According to one embodiment, the heater assembly may store a large amount of air inside the accommodation space by having the structure 590 including the first portion 590a, and as a large amount of air flows into the aerosol generating article, an aerosol having a rich flavor and taste of smoke may be generated from the aerosol generating article. In addition, because the accommodation space stores a large amount of air, the heat generated from the aerosol generating article may be prevented from being transferred to the outside of a resonance unit (for example, the resonance unit 530 of FIG. 17), and thus, the entire insulation performance of the resonance unit may also be increased.

In another example, the structure 590 may include the second portion 590b extending in a longitudinal direction of the accommodation space from the first portion 590a to surround at least a part of an outer circumferential surface of the aerosol generating article inserted into the accommodation space. The aerosol generating article inserted into the accommodation space may be at a point fixed in the accommodation space by the first portion 590a and/or the second portion 590b of the structure 590.

As the heater assembly according to one embodiment includes the structure 590 including the first portion 590a and the second portion 590b, a tobacco rod (for example, the tobacco rod 11 of FIG. 17) of the aerosol generating article may be placed at a point where a strong electric field is generated.

The structure 590 may include a plurality of portions placed inside the accommodation space and arranged along a circumferential direction of an inner surface of the accommodation space. The structure 590 may include an air inlet passage 591 connecting the accommodation space to the aerosol generating article, and the air inlet passage 591 may be formed in a space between the plurality of portions.

For example, the air inlet passage 591 may be formed in a space between first portions 590a arranged adjacent to each other and between second portions 590b arranged adjacent to each other. External air may move in a longitudinal direction (for example, the −z-axis direction) of the accommodation space to the air inlet passage 591, and may be introduced into one end of the aerosol generating article through the air inlet passage 591.

The external air introduced into one end of the aerosol generating article through the air inlet passage 591 may be mixed with the vapor generated as the aerosol generating article is heated to generate an aerosol, and the generated aerosol may be discharged to the outside of the heater assembly by passing through the aerosol generating article.

As the heater assembly according to one embodiment includes the structure 590 including the first portion 590a and the second portion 590b, the heater assembly may support an aerosol generating article while not impeding the flow of external air toward the aerosol generating article.

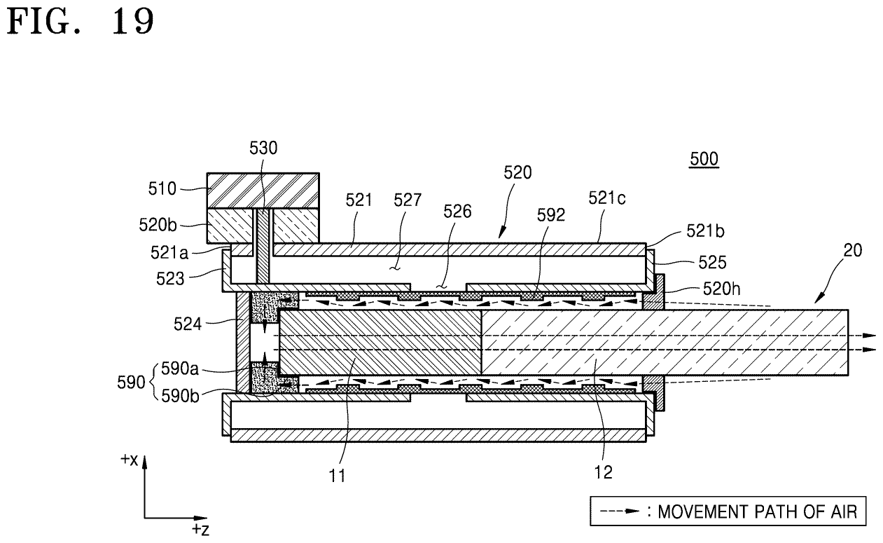

Hereinafter, a protrusion portion of the heater assembly is described with reference to FIG. 19.

FIG. 19 is another example of a cross-sectional view of the heater assembly of FIG. 4. FIG. 19 illustrates another example of a cross-sectional view of the heater assembly of FIG. 4, which is taken along line A-A′, and arrows in FIG. 19 indicate movement paths of air (or “external air”).

Referring to FIG. 19, a heater assembly 500 according to one embodiment may include an oscillator 510, a resonance unit 520, a coupler 530, a structure 590, and a protrusion portion 592. The heater assembly 500 of FIG. 19 may be an assembly in which only the protrusion portion 592 is added to the heater assembly of FIG. 17, and at least some of components of the heater assembly 500 of FIG. 19 may be identical or similar to the components of the heater assembly of FIG. 17.

The structure 590 may be arranged inside the first inner conductor 523 and may support a part of an aerosol generating article 10 inserted into the accommodation space. For example, the structure 590 may support one end of the aerosol generating article 10 such that the aerosol generating article 10 may be separated from an accommodation space in a direction (for example, the +z-axis direction) toward the outside of the heater assembly 500. In another example, the structure 590 may support a part of an outer circumferential surface of the aerosol generating article 10 such that the aerosol generating article 10 may be at a fixed point in the accommodation space. A tobacco rod 11 of the aerosol generating article 10 may be arranged at a position corresponding to a gap 526 between a first inner conductor 523 and a second inner conductor 525 by the structure 590.

The structure 590 may include the protrusion portion 592 that is separated from the second portion 590b in a longitudinal direction (for example, the +z-axis direction) of the accommodation space by a preset distance and protrudes in the longitudinal direction of the accommodation space. The protrusion portion 592 may be on an inner surface of the accommodation space and may surround at least a part of an outer circumferential surface of the aerosol generating article 20 inserted into the accommodation space.

The protrusion portion 592 may further include one or more protrusions protruding from an inner surface of the accommodation space in a width direction (for example, the x-axis direction) of the accommodation space, and the outer circumferential surface of the aerosol generating article 20 inserted into the accommodation space may be supported by the one or more protrusions.

External air introduced into the accommodation space through an air inlet hole of the insertion portion 520h may be introduced into one end (for example, one end of the z-axis) of the aerosol generating article 20 along a movement path of a zigzag shape by the protrusion portion 592. However, the movement path of the external air according to the protrusion portion 592 is not limited thereto and may be formed in various shapes depending on embodiments.

The heater assembly 500 according to one embodiment may store a large amount of air inside the accommodation space by including the structure 590 including the protrusion portion 592. Accordingly, an aerosol generating device including the heater assembly 500 according to one embodiment may generate an aerosol having a rich flavor and taste of smoke, and may also increase insulation performance of the resonance unit 520 by preventing the heat generated from the aerosol generating article 20 from being transferred to the outside of the resonance unit 520.

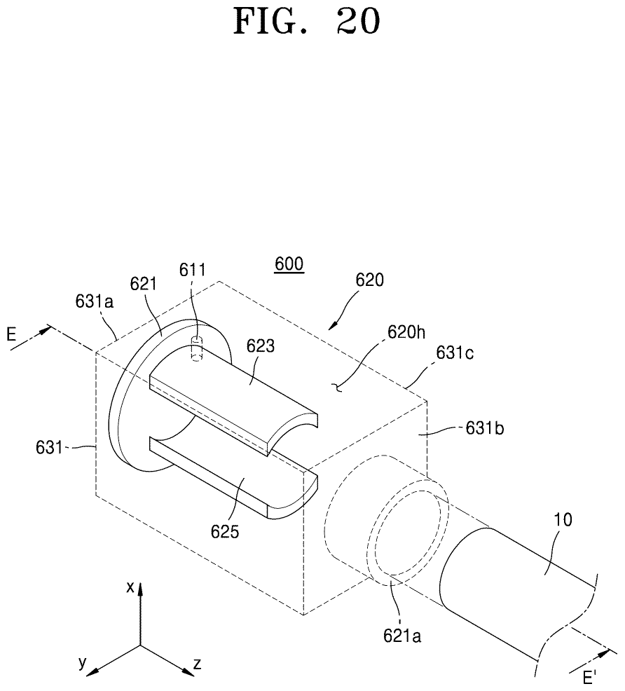

FIG. 20 is a perspective view of a heater assembly according to another embodiment.

Referring to FIG. 20, a heater assembly 600 according to another embodiment may include a resonance unit 620 and a coupler 611. Components of the heater assembly 600 may be identical or similar to at least one of the components of the heater assembly 500 of FIGS. 17 and 19, and accordingly, redundant descriptions thereof are omitted below.

An oscillator may generate microwaves in a designated frequency band when an AC voltage is applied, and the microwaves generated by the oscillator may be transmitted to the resonance unit 620 through the coupler 611.

The oscillator may be fixed to the resonance unit 620 by a bracket protruding in the x direction from the resonance unit 620 in order to prevent the oscillator from being separated from the resonance unit 620 during the use of an aerosol generating device (for example, the aerosol generating device 100 of FIG. 1).

The resonance unit 620 may surround at least a part of an aerosol generating article 10 inserted into an aerosol generating device (for example, the aerosol generating device 100 of FIG. 1) and may heat the aerosol generating article 10 according to the microwaves generated by the oscillator 310. For example, dielectrics included in the aerosol generating article 10 may generate heat by an electric field generated inside the resonance unit 620 by resonance of microwaves, and the aerosol generating article 10 may be heated by the heat generated from the dielectrics.

The resonance unit 620 according to one embodiment may include an outer conductor 631, a plurality of first inner conductors 623 and 625, and a connection portion 621.

The outer conductor 631 may form the entire appearance of the resonance unit 620 and has an inner portion formed as a hollow shape, and accordingly, components of the resonance unit 620 may be arranged inside the outer conductor 631. For example, the outer conductor 631 may be formed as a square column having a square cross-section as a whole but is not limited thereto. In another example, the outer conductor 631 may also be formed as a polygonal column having a rectangular, elliptical, or circular cross-section.

The outer conductor 631 may include an accommodation space in which the aerosol generating article 10 may be accommodated, and a support member 621a that may support the aerosol generating article 10 inserted into the accommodation space. One region of the aerosol generating article 10 may be inserted into the outer conductor 631 through the accommodation space, and the other region of the aerosol generating article 10 may be exposed to the outside of the resonance unit 620. The support member 621a may support the other region of the aerosol generating article 10 exposed to the outside of the resonance unit 620.

The outer conductor 631 may include a first surface 631a, a second surface 631b facing the first surface 631a, and a side surface 631c surrounding a free space between the first surface 631a and the second surface 631b. At least some (for example, the plurality of first inner conductors 623 and 625) of components of the resonance unit 620 may be arranged in an inner space of the resonance unit 620 formed by the first surface 631a, the second surface 631b and the side surface 631c.

The plurality of first inner conductors 623 and 625 may be formed in a plate shape extending in a direction from the first surface 631a of the outer conductor 631 toward an inner space of the outer conductor 631. For example, the plurality of first inner conductors 623 and 625 may be separated from each other along a circumference of the aerosol generating article 10 accommodated in the accommodation space, and one (for example, the first inner conductor 623) of the plurality of first inner conductors 623 and 625 may surround one region of the aerosol generating article 10, and the other (for example, the first inner conductor 625) may surround the other region of the aerosol generating article 10.

One region of the first inner conductor 623 may be in contact with the coupler 611 connected to the oscillator, and an electric field may be generated inside the plurality of first inner conductors 623 and 625 as microwaves transmitted through the coupler 611 resonate. For example, the coupler 611 may penetrate the outer conductor 631, and have one end in contact with the oscillator and the other end in contact with one region of the first inner conductor 623, and as the microwaves generated by the oscillator is transmitted to the first inner conductor 623 through the coupler 611, an electric field may be generated inside the plurality of first inner conductors 623 and 625.

The resonance unit 620 may include a closed end of which cross-section is closed to have a quarter (λ/4) of a wavelength (λ) of a microwave, and an open end that is in an opposite direction of the closed end and has at least one open region of a cross-section.

The resonance unit 620 may include the connection portion 621 in contact with one end of each of the plurality of first inner conductors 623 and 625 to close cross-sections of the plurality of first inner conductors 623 and 625. As one end of each of the cross-sections of the plurality of first internal conductors 623 and 625 is closed by the connection portion 621, a closed end may be formed at one end of each of the plurality of first internal conductors 623 and 625. Because the other end of each of the plurality of first internal conductors 623 and 625 is separated from the connection portion 621 so as not to come into contact with the connection portion 621, an open end may be formed at the other end of each of the plurality of first internal conductors 623 and 625. That is, when viewed on an xz plane, the plurality of first internal conductors 623 and 625 may be formed in a “ [symbol] ” shape as a whole to include the closed end and open end, and the plurality of first internal conductors 623 and 625 may operate as resonators having a quarter of a wavelength of a microwave due to a structure of the plurality of first internal conductors 623 and 625 described above.

Resonance of microwaves may be formed between the first inner conductor 623 and the outer conductor 631, between the first inner conductor 625 and the outer conductor 631, and between the first inner conductor 623 and the first inner conductor 625. Accordingly, an electric field may be generated between the plurality of first inner conductors 623 and 625 and the outer conductor 631.

Although two first inner conductors 623 and 625 are illustrated in FIG. 20, the embodiments are not limited thereto, and for example, the plurality of first inner conductors 623 and 625 may include three or more first inner conductors.

A triple resonance mode may be formed inside the resonance unit 620. For example, resonance of a transverse electric & magnetic (TEM) mode of microwaves may be formed inside the plurality of first inner conductors 623 and 625, and resonance of a TEM mode different from the resonance formed inside the plurality of first inner conductors 623 and 625 may be formed between the first inner conductor 623 and the outer conductor 631 and between the first inner conductor 625 and the outer conductor 631. As the triple resonance mode is formed inside the resonance unit 620, the aerosol generating article 10 accommodated inside the resonance unit 620 may be heated more uniformly.

A secondary heating operation may be performed on the aerosol generating article 10 by a magnetic field due to the resonance mode formed between the plurality of first inner conductors 623 and 625 and the outer conductor 631.

According to a resonance structure of the resonance unit 620 described above, an electric field may not be transferred to an external region of the resonance unit 620. Therefore, the heater assembly 600 may prevent an electric field from leaking to the outside of the heater assembly 600 even without a separate shielding member for shielding the electric field.

A resonance peak is formed at the other end of each of the plurality of first internal conductors 623 and 625 such that a stronger electric field may be generated compared to other areas, and by arranging a tobacco rod including a dielectric that may generate heat by the electric field at a position corresponding to a region where the electric field is strongest, heating efficiency (or “dielectric heating efficiency”) of the heater assembly 600 may be increased.

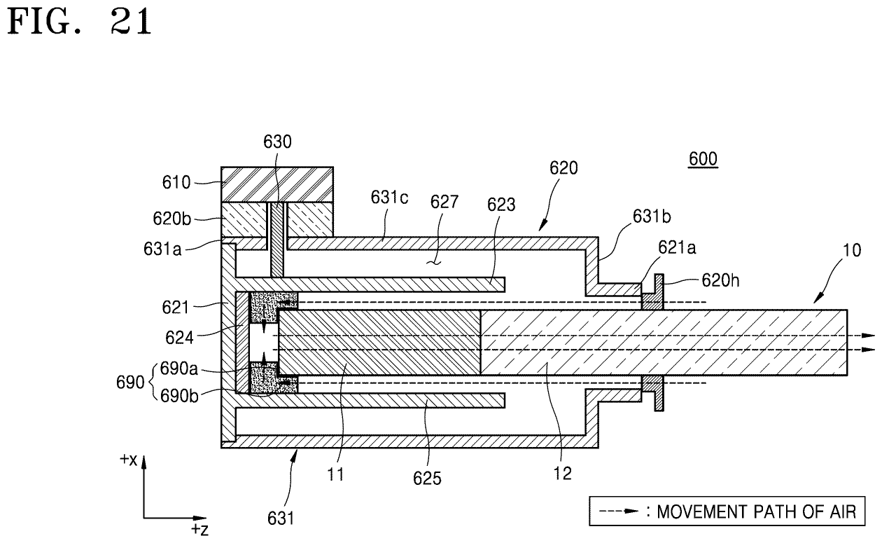

Hereinafter, a structure of the heater assembly 600 is specifically described with reference to FIG. 21.

FIG. 21 is an example of a cross-sectional view of the heater assembly 600 of FIG. 20. FIG. 21 illustrates an example of the cross-sectional view of the heater assembly 600 of FIG. 20 which is taken along line E-E′, and arrows in FIG. 21 indicate movement paths of air.

Referring to FIG. 21, the heater assembly 600 according to one embodiment may include an oscillator 610, a resonance unit 620, a coupler 630, and a structure 690.

The oscillator 610 may generate microwaves in a designated frequency band as an AC voltage is applied, and the microwaves generated by the oscillator 610 may be transmitted to the resonance unit 620 through the coupler 630.

The oscillator 610 may be fixed to the resonance unit 620 to prevent separation from the resonance unit 620 during the use of an aerosol generating device (for example, the aerosol generating device 100 of FIG. 1). For example, the oscillator 610 may be fixed on the resonance unit 620 by being supported by a bracket 620b protruding in the x direction in one region of the resonance unit 620. In another example, the oscillator 610 may be fixed on the resonance unit 620 by being attached to one region of the resonance unit 620 without the bracket 620b.

The resonance unit 620 may surround at least a part of the aerosol generating article 10 inserted into an aerosol generating device (for example, the aerosol generating device 100 of FIG. 1) and may heat the aerosol generating article 10 according to the microwaves generated by the oscillator 610. For example, dielectrics included in the aerosol generating article 10 may generate heat by an electric field generated inside the resonance unit 620 by resonance of microwaves, and the aerosol generating article 10 may be heated by the heat generated from the dielectrics.

According to one embodiment, the resonance unit 620 may include an outer conductor 631, a plurality of first inner conductors 623 and 625, and a connection portion 621.

The outer conductor 631 may form the entire appearance of the resonance unit 620 and has an inner portion formed as a hollow shape, and accordingly, components of the resonance unit 620 may be arranged inside the outer conductor 631. For example, the outer conductor 631 may be formed as a square column having a square cross-section as a whole but is not limited thereto. In another example, the outer conductor 631 may also be formed as a polygonal column having a rectangular, elliptical, or circular cross-section.

The outer conductor 631 may include an accommodation space in which the aerosol generating article 10 may be accommodated, and a support member 621a that may support the aerosol generating article 10 inserted into the accommodation space. One region of the aerosol generating article 10 may be inserted into the outer conductor 631 through the accommodation space, and the other region of the aerosol generating article 10 may be exposed to the outside of the resonance unit 620. The support member 621a may support the other region of the aerosol generating article 10 exposed to the outside of the resonance unit 620.

The outer conductor 631 may include a first surface 631a, a second surface 631b facing the first surface 631a, and a side surface 631c surrounding a free space between the first surface 631a and the second surface 631b. At least some (for example, the plurality of first inner conductors 623 and 625) of components of the resonance unit 620 may be arranged in an inner space of the resonance unit 620 formed by the first surface 631a, the second surface 631b and the side surface 631c.

The plurality of first inner conductors 623 and 625 may be formed in a plate shape extending in a direction from the first surface 631a of the outer conductor 631 toward an inner space of the outer conductor 631. For example, the plurality of first inner conductors 623 and 625 may be separated from each other along a circumference of the aerosol generating article 10 accommodated in the accommodation space, and one (for example, the first inner conductor 623) of the plurality of first inner conductors 623 and 625 may surround one region of the aerosol generating article 10, and the other (for example, the first inner conductor 625) may surround the other region of the aerosol generating article 10.

One region of the first inner conductor 623 may be in contact with the coupler 611 connected to the oscillator, and an electric field may be generated inside the plurality of first inner conductors 623 and 625 as microwaves transmitted through the coupler 611 resonate. For example, the coupler 611 may penetrate the outer conductor 631, and have one end in contact with the oscillator and the other end in contact with one region of the first inner conductor 623, and as the microwaves generated by the oscillator is transmitted to the first inner conductor 623 through the coupler 611, an electric field may be generated inside the plurality of first inner conductors 623 and 625.

According to one example, the resonance unit 620 may include a closed end of which cross-section is closed to have a quarter (λ/4) of a wavelength (λ) of a microwave, and an open end that is in an opposite direction of the closed end and has at least one open region of a cross-section.

The resonance unit 620 may include the connection portion 621 in contact with one end of each of the plurality of first inner conductors 623 and 625 to close cross-sections of the plurality of first inner conductors 623 and 625. As one end of each of the cross-sections of the plurality of first internal conductors 623 and 625 is closed by the connection portion 621, a closed end may be formed at one end of each of the plurality of first internal conductors 623 and 625. Because the other end of each of the plurality of first internal conductors 623 and 625 is separated from the connection portion 621 so as not to come into contact with the connection portion 621, an open end may be formed at the other end of each of the plurality of first internal conductors 623 and 625. That is, when viewed on an xz plane, the plurality of first internal conductors 623 and 625 may be formed in a “ [symbol] ” shape as a whole to include the closed end and open end, and the plurality of first internal conductors 623 and 625 may operate as resonators having a quarter of a wavelength of a microwave due to a structure of the plurality of first internal conductors 623 and 625 described above.

According to one embodiment, the resonance unit 620 may further include a dielectric accommodation space 627 and a dielectric accommodated in the dielectric accommodation space 627 to adjust a dielectric constant of the resonance unit 620.

The dielectric accommodation space 627 may indicate a free space between the outer conductor 621 and the plurality of first inner conductors 623 and 625, and the dielectric may be accommodated in the dielectric accommodation space 627. For example, the dielectric may be at least one of quartz with low microwave absorption, tetrafluoroethylene, and aluminum oxide, or a combination thereof, but the type of the dielectric is not limited thereto.

In the heater assembly 600 according to one embodiment, by arranging the dielectric inside the dielectric accommodation space 627, the entire size of the resonance unit 620 may be reduced, and an electric field identical to the electric field generated by the resonance unit 620 that does not include a dielectric may be generated. That is, in the heater assembly 600 according to another embodiment, a size of the resonance unit 620 may be reduced by the dielectric arranged inside the dielectric accommodation space 627, and accordingly, an accommodation space of the resonance unit 620 in the aerosol generating device may be reduced, and as a result, the aerosol generating device (for example, the aerosol generating device 100 of FIG. 1) may be reduced in size.

A resonance peak is formed at the other end of each of the plurality of first internal conductors 623 and 625 such that a stronger electric field may be generated compared to other areas, and by arranging a tobacco rod 11 including a dielectric that may generate heat by the electric field at a position corresponding to a region where the electric field is strongest, heating efficiency (or “dielectric heating efficiency”) of the heater assembly 600 may be increased.

The structure 690 may be arranged inside the plurality of first internal conductors 623 and 625 and support a part of the aerosol generating article 10 inserted into the accommodation space. For example, the structure 690 may support one end of the aerosol generating article 10, and accordingly, the aerosol generating article 10 may be separated from the accommodation space in a direction (for example, the +z-axis direction) toward the outside of the heater assembly 600. In another example, the structure 690 may support a part of an outer circumferential surface of the aerosol generating article 10, and accordingly, the aerosol generating article 10 may be at a fixed point in the accommodation space. The tobacco rod 11 of the aerosol generating article 10 may be arranged at a position corresponding to ends (for example, ends of the +z axis) of the plurality of first internal conductors 623 and 625 by the structure 690.

The heater assembly 600 according to one embodiment may store a large amount of air inside the accommodation space as the aerosol generating article 10 is supported by the structure 690. Accordingly, an aerosol generating device including the heater assembly 600 according to one embodiment may generate an aerosol having a rich flavor and taste of smoke from the aerosol generating article 10 into which a large amount of air in the accommodation space is introduced. Also, the heat generated from the aerosol generating article 10 by the large amount of air in the accommodation space may be prevented from being transferred to the outside of the resonance unit 620, and accordingly, the heater assembly 600 according to one embodiment may increase the entire insulation performance of the resonance unit 620.

The structure 690 may include an air inlet passage that introduces external air, which is introduced into the accommodation space, into the aerosol generating article 10. For example, the air inlet passage may connect the accommodation space to one end (for example, one end in the −z-axis direction) of the aerosol generating article 10 inserted into the accommodation space. External air introduced into the accommodation space through the air inlet hole of an insertion portion 620h may be introduced into one end of the aerosol generating article 10 through the air inlet passage of the structure 690.

The external air introduced into one end of the aerosol generating article 10 through the air inlet passage may be mixed with the vapor generated as the aerosol generating article 10 is heated to generate an aerosol, and the generated aerosol may be discharged to the outside of the heater assembly 600 by passing through the aerosol generating article 10.

The heater assembly 600 according to one embodiment may have the structure 690 including the air inlet passage to support the aerosol generating article 10 while not impeding a flow of external air toward the aerosol generating article 10.

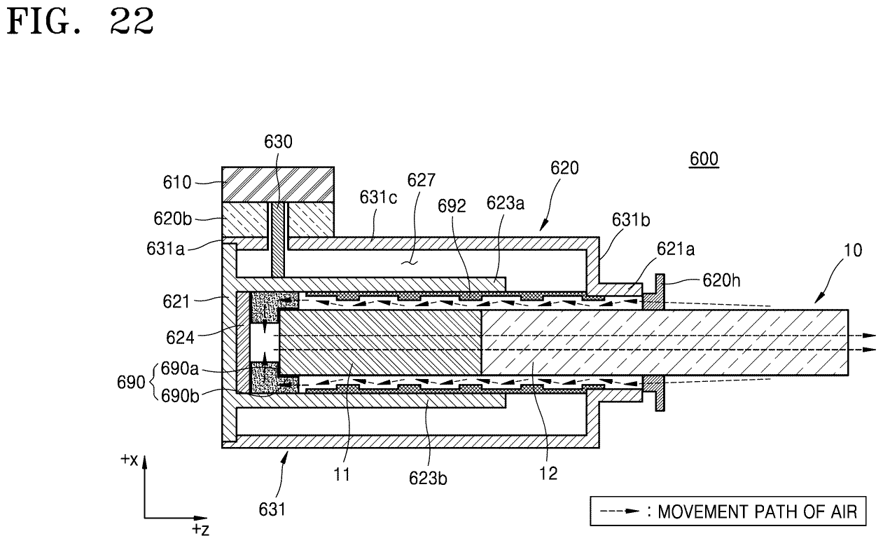

Hereinafter, a protrusion portion of the heater assembly 600 is described with reference to FIG. 22.

FIG. 22 is another example of the cross-sectional view of the heater assembly 600 of FIG. 20. FIG. 22 illustrates another example of the cross-sectional view of the heater assembly 600 of FIG. 20 which is taken along line E-E′, and arrows in FIG. 22 indicate movement paths of air (or “external air”).

Referring to FIG. 22, the heater assembly 600 according to one embodiment may include an oscillator 610, a resonance unit 620, a coupler 630, a structure 690, and a protrusion portion 692. The heater assembly 600 of FIG. 22 may be an assembly in which only the protrusion portion 692 is added to the heater assembly of FIG. 21, and at least some of components of the heater assembly 600 of FIG. 22 may be identical or similar to the components of the heater assembly of FIG. 21.

The structure 690 may be arranged inside a plurality of first inner conductors 623 and 625 and may support a part of an aerosol generating article 10 inserted into an accommodation space. For example, the structure 690 may support one end of the aerosol generating article 10 such that the aerosol generating article 10 may be separated from an accommodation space in a direction (for example, the +z-axis direction) toward the outside of the aerosol generating device (for example, the aerosol generating device 100 of FIG. 1). In another example, the structure 690 may support a part of an outer circumferential surface of the aerosol generating article 10 such that the aerosol generating article 10 may be at a fixed point in the accommodation space. A tobacco rod 11 of the aerosol generating article 10 may be arranged at a position corresponding to ends (for example, an end of the +z axis) of the plurality of first inner conductors 623 and 625 by the structure 690.

The structure 690 may include a protrusion 692 protruding from a second portion 690b in a longitudinal direction (for example, the +z-axis direction) of an accommodation space. The protrusion portion 692 may be on an inner surface of the accommodation space and may surround at least a part of an outer circumferential surface of the aerosol generating article 10 inserted into the accommodation space.

The protrusion portion 692 may further include one or more protrusions protruding from an inner surface of the accommodation space in a width direction (for example, the x-axis direction) of the accommodation space, and the outer circumferential surface of the aerosol generating article 10 inserted into the accommodation space may be supported by the one or more protrusions.

External air introduced into the accommodation space through an air inlet hole of an insertion portion 620h may be introduced into one end (for example, one end of the −z-axis) of the aerosol generating article 10 along a movement path of a zigzag shape by the protrusion portion 692. However, the movement path of the external air according to the protrusion portion 692 is not limited thereto and may be formed in various shapes depending on embodiments.

The heater assembly 600 according to one embodiment may store a large amount of air inside the accommodation space by including the structure 690 including the protrusion portion 692. Accordingly, an aerosol generating device including the heater assembly 600 according to one embodiment may generate an aerosol having a rich flavor and taste of smoke, and may also increase insulation performance of the resonance unit 620 by preventing the heat generated from the aerosol generating article 10 from being transferred to the outside of the resonance unit 620.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present disclosure should be defined by a reasonable interpretation of the appended claims, and all modifications that fall within the equivalent scope of the present disclosure are included in its scope.

1. A heater assembly comprising:
an oscillator configured to generate a microwave in a designated frequency band; and
a resonance unit configured to receive the microwave generated by the oscillator through a coupler and cause the received microwave to resonate to generate an electric field,
wherein the resonance unit comprises:
an outer conductor including an accommodation space for accommodating an aerosol generating article, wherein the outer conductor comprises a first surface, a second surface facing the first surface, and a side surface surrounding an inner space between the first surface and the second surface;
a first inner conductor extending from the first surface in a direction toward the inner space and surrounding one region of the aerosol generating article accommodated in the accommodation space; and
a second inner conductor extending from the second surface in the direction toward the inner space and surrounding another region of the aerosol generating article accommodated in the accommodation space, and
the aerosol generating article accommodated in the accommodation space is heated by the electric field generated by the resonance unit.

2. The heater assembly of claim 1, wherein
the first inner conductor is formed in a hollow cylindrical shape surrounding the one region of the aerosol generating article accommodated in the accommodation space, and
the second inner conductor is arranged in the inner space and separated from the first inner conductor by a preset distance, and is formed in a hollow cylindrical shape surrounding the other region of the aerosol generating article accommodated in the accommodation space.

3. The heater assembly of claim 2, wherein
a first region, which is formed by the first surface of the outer conductor, the side surface of the outer conductor, and the first inner conductor, operates as a resonator having a quarter of a wavelength of the microwave generated by the oscillator, and
a second region, which is formed by the second surface of the outer conductor, the side surface of the outer conductor, and the second inner conductor, operates as another resonator having a quarter of the wavelength of the microwave generated by the oscillator.

4. The heater assembly of claim 1, wherein the resonance unit further comprises an airflow passage arranged to cause external air to move along a longitudinal direction of the accommodation space and then to be introduced into one end of the aerosol generating article accommodated in the accommodation space.

5. The heater assembly of claim 4, wherein the resonance unit further comprises a structure arranged inside the accommodation space and configured to support at least one region of the aerosol generating article accommodated in the accommodation space.

6. The heater assembly of claim 5, wherein
the structure comprises an air inlet hole penetrating the structure and connected to the airflow passage, and
external air moving along the airflow passage is introduced into the one end of the aerosol generating article through the air inlet hole.

7. The heater assembly of claim 1, wherein the resonance unit further comprises:
a support member arranged inside the accommodation space and surrounding at least one region of the aerosol generating article accommodated in the accommodation space to support the aerosol generating article; and
a fixing member fixing the support member to an inside of the accommodation space.

8. The heater assembly of claim 1, wherein the resonance unit further comprises a structure arranged inside the first inner conductor and the second inner conductor to surround the aerosol generating article inserted into the accommodation space, and configured to prevent an aerosol generated from the aerosol generating article from moving toward the first inner conductor or the second inner conductor.

9. The heater assembly of claim 8, wherein the resonance unit further comprises a fixing member fixing the structure to an inside of the accommodation space.

10. The heater assembly of claim 9, wherein the structure comprises:
a first portion accommodating one end of the aerosol generating article inserted into the accommodation space; and
a second portion formed in a hollow cylindrical shape extending from the first portion in a longitudinal direction of the accommodation space and surrounding an outer circumferential surface of the aerosol generating article.

11. The heater assembly of claim 10, wherein,
when the aerosol generating article is inserted into the accommodation space, an airflow passage is formed between the aerosol generating article and the second portion, and
air outside the resonance unit is introduced into the resonance unit through the airflow passage, and then moves in a direction toward the one end of the aerosol generating article.

12. The heater assembly of claim 1, wherein
the resonance unit further comprises a structure arranged inside the accommodation space to support the aerosol generating article inserted into the accommodation space and inducing external air to the aerosol generating article accommodated in the accommodation space, and
the structure comprises an air inlet passage arranged to cause external air introduced into the accommodation space to be introduced to one end of the aerosol generating article accommodated in the accommodation space.

13. The heater assembly of claim 12, wherein the structure comprises a plurality of portions arranged along a peripheral direction of an inner circumferential surface of the accommodation space, and
the air inlet passage is formed in a space between the plurality of portions.

14. The heater assembly of claim 12, wherein the structure comprises a first portion in contact with at least one region of the aerosol generating article inserted into the accommodation space, and a second portion extending from the first portion in a longitudinal direction of the accommodation space to surround at least a part of an outer circumferential surface of the aerosol generating article.

15. An aerosol generating device comprising:
a housing including an insertion hole into which an aerosol generating article is inserted; and
the heater assembly according to claim 1.
